(19) United States
(12) Patent Application Publication
(10) Pub. No.: US 2024/0395013 A1
(43) Pub. Date: Nov. 28, 2024

(54) METHOD AND ELECTRONIC DEVICE FOR MANAGING FOREIGN MATTER IN LIQUID PRODUCT, AND METHOD AND ELECTRONIC DEVICE FOR IMPROVING FOREIGN MATTER DETECTION THROUGH CHANNEL MANAGEMENT

(71) Applicant: SK Planet Co., Ltd., Seongnam-si (KR)

(72) Inventor: Yeonghyeon PARK, Suwon-si (KR)

(21) Appl. No.: 18/674,921

(22) Filed: May 27, 2024

(30) Foreign Application Priority Data
May 25, 2023 (KR) 10-2023-0067682
May 25, 2023 (KR) 10-2023-0067683
Aug. 22, 2023 (KR) 10-2023-0109777

(51) Int. Cl. G06V 10/74; G01N 21/25; G01N 21/31; G06V 10/50

(52) U.S. Cl. CPC G06V 10/761; G01N 21/255; G01N 21/314; G06V 10/50

(57) ABSTRACT

Embodiments relate to acquiring a spectral image of a liquid product including a liquid substance injected therein. A data cube corresponding to the spectral image captured for the liquid substance of the liquid product is acquired. The data cube may be divided into windows of a predetermined size. A current relationship matrix indicating a relationship between pixel values included in the divided windows is obtained. Whether the liquid product contains a foreign matter is determined, based on the current relationship matrix.

### CROSS-REFERENCE TO RELATED APPLICATIONS

The present application is based upon and claims the benefit of priority to Korean Patent Application Nos. 10-2023-0067682, filed on May 25, 2023, 10-2023-0067683, filed on May 25, 2023, and 10-2023-0109777, filed on Aug. 22, 2023. The disclosures of the above-listed applications are incorporated by reference herein in their entirety.

### TECHNICAL FIELD

The present disclosure relates to foreign matter management technology for liquid products and foreign matter detection technology through channel management of captured images.

### BACKGROUND ART

Cosmetics can broadly take the form of solid, liquid, or gel. Typical examples of solid cosmetics are powder cosmetics, liquid cosmetics include liquid foundation and skin cosmetics, and gel cosmetics include gel foundation, lotion, and cream cosmetics. In particular, liquid cosmetics have a relatively high skin absorption rate, so many cosmetics are in liquid form.

A manufacturing process of liquid cosmetics includes injecting cosmetics into a specific container, closing a container hole, and packaging a product. During this process, foreign matter may enter or unintended liquid crystals may be formed, resulting in defective products. In order to detect such defective products, many inspectors must inspect each cosmetic product, requiring a lot of time, money, and effort. In addition to cosmetics, various liquid products are sold sealed after being injected into containers that can be observed from the outside. These products, like cosmetics, also need to be checked for defects.

In order to check whether foreign matter is contained in the product, various pieces of scanning information about foreign matter may be collected and inspected from various angles. Since this method requires very large resources to detect foreign matter, the time and cost spent on foreign matter detection may increase.

### SUMMARY

Accordingly, the present disclosure is intended to provide a foreign matter management method and electronic device capable of detecting whether foreign matter is contained in a liquid product.

Additionally, the present disclosure is intended to provide an improved foreign matter detection method and electronic device capable of detecting whether foreign matter is contained in a product through an efficient routine.

According to an embodiment of the present disclosure, a foreign matter management device may include a spectral camera acquiring a spectral image of a liquid product including a liquid substance injected therein; a memory storing the spectral image; and a processor functionally connected to the spectral camera and the memory. The processor may be configured to acquire a data cube corresponding to the spectral image captured for the liquid substance of the liquid product, to divide the data cube into windows of a predetermined size, to calculate a current relationship matrix indicating a relationship between pixel values included in the divided windows, and to determine whether the liquid product contains a foreign matter, based on the current relationship matrix.

The processor may be configured to search all or part of the data cube with a sliding window of a size specified by a user input, or search all or part of the data cube by setting the sliding window as a hyper-parameter within an algorithm stored in the memory and automatically selecting an optimal sliding window.

The processor may be configured to search the data cube with a sliding window of a specified size, divide each sliding window into at least one pixel unit, calculate similarities between divided pixel unit values, and calculate the current relationship matrix based on the calculated similarities.

The processor may be configured to calculate the similarities by applying a cosine similarity function.

The processor may be configured to, when a similarity different from surrounding similarities by more than a reference value is detected from among the similarities, determine that the liquid product corresponding to the current relationship matrix contains a foreign matter.

The processor may be configured to search the data cube with a sliding window of a specified size, divide each sliding window into at least one pixel unit, calculate distance values between divided pixel unit values, and calculate the current relationship matrix based on the calculated distance values.

The processor may be configured to calculate the distance values by applying a Euclidean distance function.

The processor may be configured to, when a distance value different from surrounding distance values by more than a reference value is detected from among the distance values, determine that the liquid product corresponding to the current relationship matrix contains a foreign matter.

The memory may store at least one of a relationship matrix including foreign matter and a relationship matrix including no foreign matter, and the processor may be configured to compare the relationship matrix including foreign matter and the current relationship matrix, and if a comparison result has a similarity greater than or equal to a reference value, determine that the liquid product corresponding to the current relationship matrix contains a foreign matter, or compare the relationship matrix including no foreign matter with the current relationship matrix, and if a comparison result has a similarity less than a reference value, determine that the liquid product corresponding to the current relationship matrix contains a foreign matter.

The processor may be configured to provide a machine learning or deep learning-based artificial intelligence model based on at least one of the data cube and the current relationship matrix.

The spectral camera may include a first spectral camera that photographs the liquid product in an upward direction, and a second spectral camera that photographs the liquid product in a downward direction, and the processor may, when detection of suspended matter of the liquid product is requested, control to collect spectral images based on the first spectral camera, and when detection of sediment of the liquid product is requested, control to collect spectral images based on the second spectral camera.

According to an embodiment of the present disclosure, a foreign matter management method for a liquid product may include acquiring a data cube corresponding to a spectral image captured for a liquid substance of the liquid product; dividing the data cube into windows of a predetermined size; calculating a current relationship matrix indicating a relationship between pixel values included in the divided windows; and determining whether the liquid product contains a foreign matter, based on the current relationship matrix.

According to an embodiment of the present disclosure, a foreign matter management device may include a spectral camera acquiring a spectral image of a liquid product including a liquid substance injected therein; a memory storing the spectral image; and a processor functionally connected to the spectral camera and the memory. The processor may be configured to acquire a data cube corresponding to the spectral image captured for the liquid substance of the liquid product, to search the data cube by sliding with windows of a given size, to allocate data existing inside or outside the windows in a search result to virtual nodes, to allocate edges establishing relationships between the virtual nodes, to calculate a graph including the virtual nodes and the edges, and to, based on the graph, determine whether the liquid product contains a foreign matter.

The processor may be configured to calculate a relationship matrix based on the virtual nodes and the edges.

The processor may be configured to map respective values representing of the windows to the virtual nodes.

The processor may be configured to allocate the virtual nodes based on at least one of machine learning including linear regression, deep learning including convolutional neural networks (CNN), and values for expressing as basic statistics of the windows.

The processor may be configured to calculate similarities between the virtual nodes and allocate the edges based on the similarities.

The processor may be configured to determine whether the foreign matter is contained, based on sizes of the similarities.

The processor may be configured to calculate the similarities by applying a cosine similarity function.

The processor may be configured to calculate distance values between the virtual nodes and allocate the edges based on the distance values.

The processor may be configured to determine whether the foreign matter is contained, based on sizes of the distance values.

The processor may be configured to calculate the distance values by applying a Euclidean distance function.

The processor may be configured to create and provide an artificial intelligence model based on machine learning or deep learning by using the virtual nodes in response to a user input, create a relationship matrix based on the virtual nodes and create and provide an artificial intelligence model based on graph theory, or create and provide an artificial intelligence model corresponding to the virtual nodes based on unsupervised learning including a K-nearest neighbors scheme.

According to an embodiment of the present disclosure, a foreign matter management method for a liquid product may include acquiring a data cube corresponding to the spectral image captured for the liquid substance of the liquid product; searching the data cube by sliding with windows of a given size; allocating data existing inside or outside the windows in a search result to virtual nodes; allocating edges establishing relationships between the virtual nodes; calculating a graph including the virtual nodes and the edges; and based on the graph, determining whether the liquid product contains a foreign matter.

According to an embodiment of the present disclosure, a foreign matter detection support device may include a spectral camera acquiring a spectral image of a product; a memory storing the spectral image; and a processor functionally connected to the spectral camera and the memory. The processor may be configured to acquire a data cube corresponding to the spectral image, to perform channel reduction to remove at least some of channels corresponding to the data cube, to generate reconstructed data by reconstructing channel-reduced data, and to perform learning on a foreign matter detection model based on the reconstructed data.

The processor may be configured to perform pixel-level decomposition on the generated data cube, and perform the channel reduction on the data cube decomposed into pixels.

The processor may be configured to extract dimensions representing characteristics of respective portions of the data cube by applying principal component analysis (PCA) or uniform manifold approximation and projection (UMAP) to the data cube, and map the extracted dimensions to virtual channels.

The processor may be configured to apply at least one of a heuristic method, a purity-based method, and an entropy-based method in relation to the channel reduction, and select at least one channel whose importance related to foreign matter detection is higher than a predefined reference value from among the channels corresponding to the data cube.

The processor may be configured to in relation to the channel reduction, remove at least one channel whose importance related to foreign matter detection is less than a predefined reference value from among the channels corresponding to the data cube.

The processor may be configured to identify a wavelength band of the spectral image corresponding to channels selected according to a channel reduction result, and change a setting value of a variable wavelength filter of the spectral camera to transmit light in the identified wavelength band, or output a message requesting a filter setting change of the spectral camera.

According to an embodiment of the present disclosure, a foreign matter detection method, performed by a control device of a foreign matter detection support device, may include acquiring a data cube corresponding to a spectral image of a product; performing channel reduction to remove at least some of channels corresponding to the data cube; generating reconstructed data by reconstructing channel-reduced data; and performing learning on a foreign matter detection model based on the reconstructed data.

### BRIEF DESCRIPTION OF DRAWINGS

FIG. 1 is a schematic diagram illustrating a foreign matter management system supporting foreign matter management for a liquid product according to the first embodiment of the present disclosure.

FIG. 2 is a block diagram illustrating a foreign matter management device according to the first embodiment of the present disclosure.

FIG. 3 is a block diagram illustrating a control device in the foreign matter management device according to the first embodiment of the present disclosure.

FIG. 4 is a block diagram illustrating a management server device according to the first embodiment of the present disclosure.

FIG. 5 is a diagram illustrating the creation of a relationship matrix according to the first embodiment of the present disclosure.

FIG. 6 is a diagram illustrating the configuration of a relationship matrix according to the first embodiment of the present disclosure.

FIG. 7 is a diagram illustrating a graph calculation according to the first embodiment of the present disclosure.

FIG. 8 is a flowchart illustrating a foreign matter management method for a liquid product according to the first embodiment of the present disclosure.

FIG. 9 is a flowchart illustrating a model operation related to the foreign matter management method for a liquid product according to the first embodiment of the present disclosure.

FIG. 10 is a flowchart illustrating a foreign matter determination method in the foreign matter management method for a liquid product according to the first embodiment of the present disclosure.

FIG. 11 is a flowchart illustrating a foreign matter determination based on a graph in the foreign matter management method for a liquid product according to the first embodiment of the present disclosure.

FIG. 12 is a flowchart illustrating a foreign matter determination through multi-stage model operation in the foreign matter management method for a liquid product according to the first embodiment of the present disclosure.

FIG. 13 is a schematic diagram illustrating a foreign matter detection support system according to the second embodiment of the present disclosure.

FIG. 14 is a block diagram illustrating a foreign matter detection support device according to the second embodiment of the present disclosure.

FIG. 15 is a block diagram illustrating a foreign matter management server device according to the second embodiment of the present disclosure.

FIG. 16 is a block diagram illustrating a server processor in the foreign matter management server device according to the second embodiment of the present disclosure.

FIG. 17 is a diagram illustrating a channel reduction technique according to the second embodiment of the present disclosure.

FIG. 18 is a diagram illustrating a channel selection technique according to the second embodiment of the present disclosure.

FIG. 19 is a flowchart illustrating a foreign matter detection model learning method related to the foreign matter detection function according to the second embodiment of the present disclosure.

FIG. 20 is a flowchart illustrating a filter setting method related to the foreign matter detection function according to the second embodiment of the present disclosure.

FIG. 21 is a flowchart illustrating a model operation related to the foreign matter management method for liquid products according to the second embodiment of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### First Embodiment

Hereinafter, an embodiment related to foreign matter management will be described with reference to the drawings.

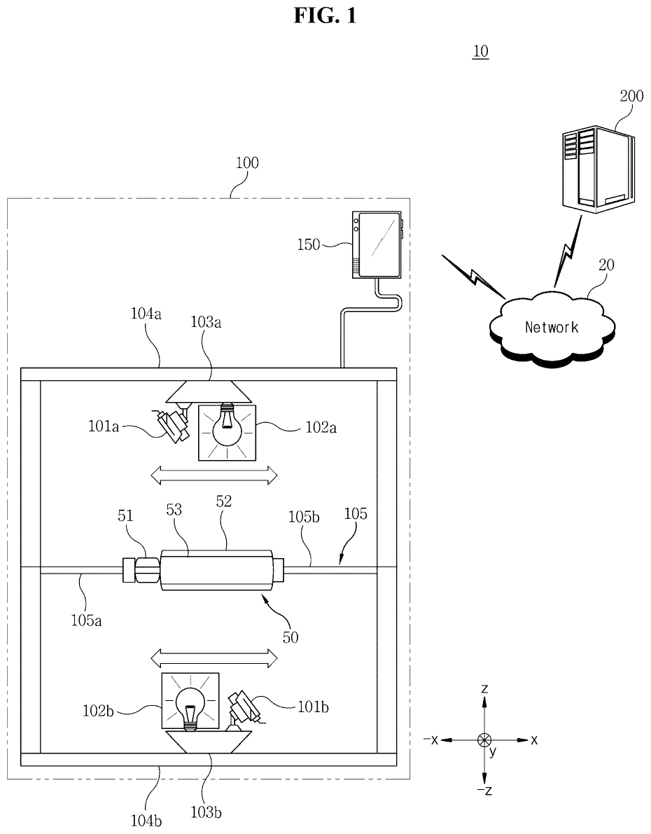

FIG. 1 is a schematic diagram illustrating a foreign matter management system supporting foreign matter management for a liquid product according to the first embodiment of the present disclosure.

Referring to FIG. 1, the foreign matter management system 10 may include a liquid product 50, a foreign matter management device 100, a network 20, and a management server device 200. In this embodiment, the foreign matter management system 10 uses the network 20 for communication between the foreign matter management device 100 and the management server device 200, but the present disclosure is not limited to this embodiment. Alternatively, the foreign matter management device 100 and the management server device 200 may be connected via a wireless communication channel using a base station or may be directly connected through a wired cable. When the foreign matter management device 100 and the management server device 200 are directly connected via a wired cable, or when the foreign matter management device 100 and the management server device 200 are integrated, the network 20 may be omitted from the foreign matter management system 10.

The liquid product 50 may include liquid cosmetics injected into a cosmetic container, perfume injected into a perfume container, various beverages or reagents injected into a container, a specific liquid mineral, or a liquid with a specific concentration. The liquid product 50 may include a transparent container 52 having a level of transparency that allows transmission observation using a spectral camera, a liquid substance 53 injected into the transparent container 52, and a cover 51 that encapsulates an entrance of the transparent container 52. The arrangement or shape of the liquid product 50 may change depending on the shape of the transparent container 52 and the direction in which the transparent container 52 is placed. Foreign matter that may be contained in the liquid product 50 may be suspended matter located at an upper portion of the transparent container 52 with respect to the center of the transparent container 52, and sediment located at a lower portion of the transparent container 52. Both the suspended matter and the sediment can be observed as foreign matter.

The foreign matter management device 100 may include at least one spectral camera 101a, 101b that collects spectral images of the liquid product 50, at least one lighting device 102a, 102b that irradiates designated light to the liquid product 50, at least one movement support device 103a, 103b on which the at least one spectral camera 101a, 101b and the at least one lighting device 102a, 102b are mounted and movable, at least one transfer rail 104a, 104b along which the at least one movement support device 103a, 103b moves, a holder device 105 for fixing the liquid product 50, and a control device 150 that controls each of the above-mentioned components. In an example, the liquid product 50 may be fixed to the holder device 105 with the cover 51 and the transparent container 52 placed horizontally.

The at least one spectral camera 101a, 101b performs a function of measuring the light reflectance of an observation target (e.g., the liquid product 50) and converting it into a spectrum. The at least one spectral camera 101a, 101b has a feature that it can record a wider wavelength band than an RGB camera, from the ultraviolet region to the infrared region, at a higher resolution than the RGB camera (in a form where the wavelength resolution is higher than that of the RGB camera). Based on this feature, the at least one spectral camera 101a, 101b supports more precise inspection of foreign matter when inspecting the inside of a bottled product because the spectra of scratches on the outside of the bottle and foreign matters inside are different. The at least one spectral camera 101a, 101b can also increase spatial resolution according to user's settings. For example, when selecting the pushbroom scanning method for spectrum recording, the foreign matter management device 100 can capture images with higher resolution in the scanning direction by adjusting the scanning speed (e.g., adjusting the speed slower than the designated speed). The foreign matter management device 100 having this feature can locally inspect pixels where a specific spectrum is located, as a state inspection method based on the at least one spectral camera 101a, 101b, to optimize the amount of calculation unlike when processing RGB images.

As shown, to fix the liquid product 50 placed in a horizontal direction (i.e., placed on the x-y plane), the holder device 105 may include holding arms 105a and 105b capable of holding one side of the liquid product 50 in the negative x-axis direction and the other side in the positive x-axis direction, respectively. The holding arms 105a and 105b may be respectively movable in the horizontal direction (i.e., the positive and negative x-axis directions) under control of the control device 150. For example, the first holding arm 105a can move in the positive x-axis direction to horizontally press the cover 51 of the liquid product 50, and the second holding arm 105b can move in the negative x-axis direction to horizontally press the bottom of the transparent container 52 of the liquid product 50.

Specifically, the foreign matter management device 100 may include a first spectral camera 101a for acquiring spectral images related to measurement of suspended matter that may occur in an upper portion of the liquid product 50, a first lighting device 102a for irradiating necessary illumination during a spectral image acquisition process, a first movement support device 103a for moving the first spectral camera 101a and the first lighting device 102a along a first transfer rail 104a, and the first transfer rail 104a for guiding the movement of the first movement support device 103a. While the first lighting device 102a irradiates light of a designated illuminance, the first spectral camera 101a can move by the first transfer rail 104a and the first movement support device 103a and acquire spectral images of an upper part of the liquid substance 53 in the transparent container 52 in a designated scheme (e.g., pushbroom scanning or line scanning, snapshot scheme, partial snapshot scheme).

Additionally, the foreign matter management device 100 may include a second spectral camera 101b for acquiring spectral images related to measurement of sediment that may occur in a lower portion of the liquid product 50, a second lighting device 102b for irradiating necessary illumination during a spectral image acquisition process, a second movement support device 103b for moving the second spectral camera 101b and the second lighting device 102b along a second transfer rail 104b, and the second transfer rail 104b for guiding the movement of the second movement support device 103b. While the second lighting device 102b irradiates light of a designated illuminance, the second spectral camera 101b can move by the second transfer rail 104b and the second movement support device 103a and acquire spectral images of a lower part of the liquid substance 53 in the transparent container 52 in a designated scheme (e.g., pushbroom scanning or line scanning, snapshot scheme, partial snapshot scheme to acquire the entire spectral image of the liquid product 50 in units of a certain window size).

Although it has been described that a first spectral camera group (e.g., the first spectral camera 101a, the first lighting device 102a, the first movement support device 103a, and the first transfer rail 104a) and a second spectral camera group (e.g., the second spectral camera 101b, the second lighting device 102b, the second movement support device 103b, and the second transfer rail 104b) are used for acquiring spectral images of the liquid product 50, the present disclosure is not necessarily limited to the above case. Alternatively, the foreign matter management device 100 may be configured to include the first spectral camera 101a, the first lighting device 102a, the first movement support device 103a, the first transfer rail 104a, and the second transfer rail 104b. In this case, the first spectral camera 101a can collect spectral images in the positive z-axis direction for the liquid product 50 while moving along the first transfer rail 104a, and then collect spectral images in the negative z-axis direction for the liquid product 50 while moving along the second transfer rail 104b.

The foreign matter management device 100 may perform analysis on the collected spectral images and determine, based on the analysis results, whether the liquid product 50 contains foreign matter. In this process, the foreign matter management device 100 may analyze a data cube corresponding to the collected spectral images, calculate a relationship matrix based on the data cube, and determine whether the foreign matter is contained based on similarity and distance calculation. Additionally, the foreign matter management device 100 may perform graph calculation for feature points based on at least one of the data cube and the relationship matrix. Also, the foreign matter management device 100 may collect a given number of data cubes and relationship matrices and then perform machine learning on the collected data to generate a foreign matter detection model. Based on the generated foreign matter detection model, the foreign matter management device 100 may determine whether a foreign matter occurs in the liquid product 50 to be newly inspected. Meanwhile, at least one of analyzing and processing spectral images for foreign matter management, determining whether foreign matter is contained, and creating a learning model may be performed in the management server device 200. In this case, the foreign matter management device 100 may perform data processing operations differently depending on a design goal. For example, the foreign matter management device 100 may be set to only perform spectral image collection and transmission. Alternatively, the foreign matter management device 100 may perform at least one of storing a data cube, calculating a relationship matrix, calculating similarity and distance between feature points, calculating a graph, and sending a message according to the foreign matter determination, and then deliver the performance result to the management server device 200.

The network 20 may establish a wireless communication channel with the foreign matter management device 100 and transmit data generated during the operation of the foreign matter management device 100 to the management server device 200 or deliver a control message (or control signal) of the management server device 200 to the foreign matter management device 100. The network 20 may include at least one communication component that supports signal transmission and reception between the foreign matter management device 100 and the management server device 200. For example, the network 20 may include various hardware components for signal transmission, such as an access point (AP), router, switch, or base station, and software modules for operating the hardware components. The network 20 may be configured to support at least one communication scheme used by the foreign matter management device 100 and the management server device 200. If the foreign matter management device 100 and the management server device 200 are integrated, the network 20 may be omitted.

The management server device 200 may establish a communication channel with the foreign matter management device 100 through the network 20. The management server device 200 may receive collected data (e.g., at least one of spectral images or data cubes, relationship matrices, graphs, foreign matter determination results, and foreign matter determination messages) from the foreign matter management device 100, and perform the subsequent operations depending on the type of the received data. In one example, the management server device 200 may perform an operation that is not performed by the foreign matter management device 100 (e.g., at least one of calculating a relationship matrix, calculating a graph, determining a foreign matter, and sending a foreign matter determination message). Alternatively, when the data cubes and relationship matrices are accumulated more than a given number, the management server device 200 may perform machine learning (e.g., supervised learning or unsupervised learning) based on at least some of the accumulated data cubes and relationship matrices, and create a learning model according to the results of machine learning. In one example, when the foreign matter management device 100 collects and transmits a new spectral image for the liquid product 50, the management server device 200 may determine whether or not foreign matter is contained in the new spectral image for the liquid product 50, based on the learning model. The management server device 200 may notify the results of whether foreign matter is contained to a designated manager terminal periodically or when an event occurs (e.g., when the foreign matter-containing liquid product 50 is detected).

Meanwhile, although it has been described above that the management server device 200 performs machine learning and creates a learning model, the present disclosure is not limited to this. Alternatively, when the management server device 200 is integrated with the foreign matter management device 100, the foreign matter management device 100 may perform machine learning and generate a learning model.

As described above, the foreign matter management system 10 according to the first embodiment of the present disclosure acquires spectral images of the liquid product 50 injected into the container, determines the foreign matter relevance of the acquired spectral images, and then notifies the same. Therefore, the foreign matter management system 10 can provide the advantage of performing more accurate quality control of liquid products.

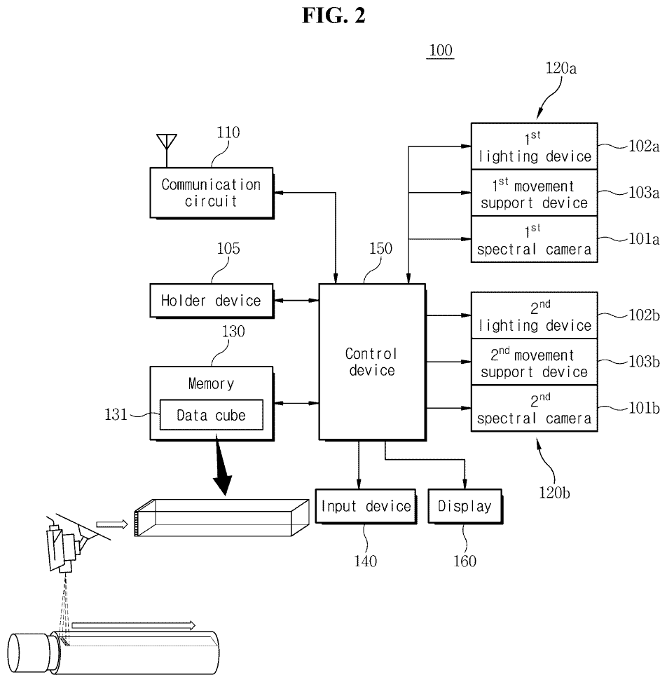

FIG. 2 is a block diagram illustrating a foreign matter management device according to the first embodiment of the present disclosure.

Referring to FIGS. 1 and 2, the foreign matter management device 100 may include the at least one spectral camera 101a, 101b, the at least one lighting device 102a, 102b, the at least one movement support device 103a, 103b, the at least one transfer rail 104a, 104b, and the holder device 105. In another example, as described above, the foreign matter management device 100 may include one spectral camera, one lighting device, and one movement support device, and may also include rails (e.g., the first transfer rail 104a and the second transfer rail 104b) provided to allow spectral images of the front and rear of the liquid product 50 to be captured.

The foreign matter management device 100 may acquire spectral images in the front direction of the liquid product 50 fixed by the holder device 105 in at least one of the pushbroom scanning scheme, the snapshot scheme, and the spectral scanning scheme, based on the first spectral camera group (e.g., the first spectral camera 101a, the first lighting device 102a, and the first movement support device 103a) and the first transfer rail 104a. For example, the first spectral camera group may acquire a plurality of spectral images in units of a region (e.g., a region corresponding to a certain width (e.g., a pixel line in the y-axis direction of the image) in the y-axis direction in FIG. 1) of the liquid product 50, and may acquire spectral images corresponding to partial regions in the positive or negative x-axis direction of the liquid product 50 while moving along the first transfer rail 104a.

The foreign matter management device 100 may acquire spectral images in the rear direction of the liquid product 50 fixed by the holder device 105 in the pushbroom scanning scheme, based on the second spectral camera group (e.g., the second spectral camera 101b, the second lighting device 102b, and the second movement support device 103b) and the second transfer rail 104b. For example, the second spectral camera group may acquire spectral images for a region (e.g., a region corresponding to a certain width (e.g., a pixel line in the y-axis direction of the image) in the y-axis direction in FIG. 1) of the liquid product 50 in the pushbroom scanning scheme (or line scanning scheme, snapshot scheme, partial snapshot scheme), and may acquire spectral images corresponding to partial regions in the positive or negative x-axis direction of the liquid product 50 while moving along the second transfer rail 104b. The second spectral camera group may be configured to acquire spectral images of foreign matter that settles because it has a higher density than the liquid raw material.

The foreign matter management device 100 may operate only the first spectral camera group, only the second spectral camera group, or both the first and second spectral camera groups, depending on the type or characteristics of the liquid product 50. In one example, when the liquid product 50 is defective and contains a liquid substance that produces sediment, the foreign matter management device 100 may operate only the second spectral camera group, collect spectral images by scanning the rear (or lower surface) of the liquid product 50 in the pushbroom scanning scheme (or at least one of line scanning scheme, patch window scheme, and snapshot scheme), and transmit the collected spectral images to the control device 150. In another example, when the liquid product 50 is defective and contains a liquid substance that produces suspended matter, the foreign matter management device 100 may operate only the first spectral camera group, collect spectral images by scanning the front (or upper surface) of the liquid product 50 in the pushbroom scanning scheme, and method to use the front (or The upper surface) may be scanned to collect, and transmit the collected spectral images to the control device 150.

Additionally or alternatively, the foreign matter management device 100 may include a communication circuit 110, a memory 130, an input device 140, a display 160, and a control device 150 (or processor).

The communication circuit 110 may establish a communication channel with the management server device 200 via the network 20. Alternatively, the communication circuit 110 may directly establish a communication channel with the management server device 200 without going through the network 20. When the management server device 200 is designed to perform foreign matter management for liquid products, the communication circuit 110 may transmit spectral images collected by at least one of the spectral camera groups (spectral images collected in the line scanning scheme) to the management server device 200. Meanwhile, the foreign matter management function for liquid products may be independently performed by the foreign matter management device 100. In this case, the communication circuit 110 may transmit the foreign matter determination result and the resulting warning message (e.g., a message requesting defect processing for the liquid product 50 injected into the container) to the management server device 200. Alternatively, the communication circuit 110 may transmit information on whether the foreign matter has occurred and information on the related liquid product 50 to a designated manager terminal in response to control of the control device 150.

The memory 130 may store at least one program or data necessary for the operation of the foreign matter management device 100. In one example, the memory 130 may store a control program necessary for driving the spectral camera groups 120a and 120b and a data cube 131 corresponding to spectral images acquired through the spectral camera groups. Additionally, the memory 130 may store a relationship matrix generated through the data cube 131, a similarity of pixels included in the relationship matrix, distance values of pixels included in the relationship matrix, a graph calculated based on at least one of the data cube 131 and the relationship matrix, and/or foreign matter determination results for the liquid product 50. Additionally, the memory 130 may store at least one of a program for generating at least one of the data cube 131 and the relationship matrix, a similarity calculation algorithm, a distance calculation algorithm, a graph calculation algorithm, and a foreign matter determination routine. The memory 130 may store a designated number of data cubes 131 and relationship matrices or more. The memory 130 may store a learning model (e.g., a supervised learning model, an unsupervised learning model) generated by performing machine learning on at least some of the data cubes 131 and relationship matrices, stored in the designated number or more. In this regard, the memory 130 may store an artificial neural network algorithm or a machine learning algorithm required for a foreign matter detection learning model for the liquid product 50. Meanwhile, at least some of such various data that can be stored in the memory 130 may be stored in the management server device 200.

The input device 140 may create a user input signal necessary for the operation of the foreign matter management device 100 in response to a user's manipulation. For example, the input device 140 may create an input signal for manual control of spectral cameras, an input signal requesting storage of the data cube 131 corresponding to the acquired spectral images (or spectral images acquired by line scanning), an input signal requesting creation of a relationship matrix from the data cube 131, an input signal requesting foreign matter determination, etc. in response to a user's manipulation, and deliver it to the control device 150. In this regard, the input device 140 may include at least one of a keyboard, a keypad, a touch screen, a jog shuttle, a jog stick, a wheel, a mouse, a voice input device, and a gesture input device.

The display 160 may output various information screens necessary for the operation of the foreign matter management device 100. For example, the display 160 may output a screen related to the operation of at least one of each spectral camera group and the holder device 105 of the foreign matter management device 100. The display 160 may output at least one screen related to the generation process and results of the data cube 131, the generation process and results of the relationship matrix, similarity calculation values, distance calculation values, graphs corresponding to at least one of the data cube 131 or the relationship matrix, and foreign matter determination results for the liquid product 50. The display 160 may include a touch screen that supports a user input function.

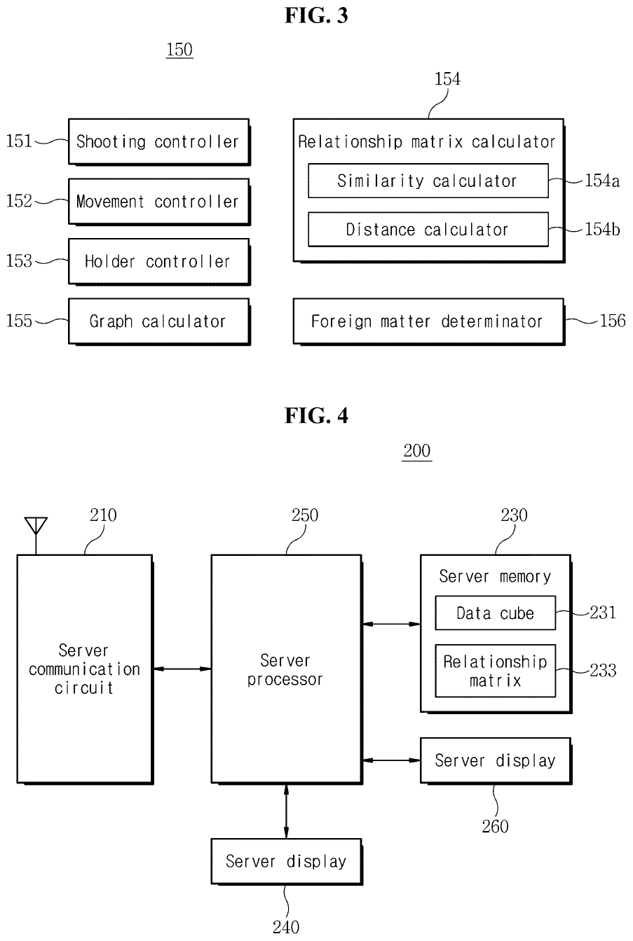

The control device 150 may control to acquire a plurality of spectral images related to the liquid product 50 injected into the container using at least one of the spectral camera groups in response to a predefined event or a request from the management server device 200. The control device 150 may perform data processing to determine foreign matter based on a plurality of acquired spectral images. In this regard, the control device 150 may include a configuration as shown in FIG. 3.

FIG. 3 is a block diagram illustrating a control device in the foreign matter management device according to the first embodiment of the present disclosure.

Referring to FIG. 3, the control device 150 (or processor) of the foreign matter management device 100 may include a shooting controller 151, a movement controller 152, a holder controller 153, a relationship matrix calculator 154, a graph calculator 155, and a foreign matter determinator 156. At least some of the above-listed components of the control device 150 may be omitted if necessary. For example, when it is set not to perform graph calculation, the control device 150 may not include the graph calculator 155.

The shooting controller 151 may perform shooting control of the at least one spectral camera 101a, 101b. For example, when the liquid product 50 is mounted on the holder device 105, the shooting controller 151 may photograph the liquid product 50 in a specific direction (e.g., direction from the top toward the ground or from the ground toward the top) by using the at least one spectral camera 101a, 101b. In this process, the shooting controller 151 may collect illuminance information necessary for photographing the liquid product 50 and control the at least one lighting device 102a, 102b to irradiate light with an illuminance corresponding to the collected illuminance information. In this process, the shooting controller 151 may adjust the illuminance of the at least one lighting device 102a, 102b based on at least one of the value of ambient illuminance and the concentration or light transmittance of the liquid substance 53 included in the liquid product 50. In this regard, the foreign matter management device 100 may further include an illuminance sensor for sensing ambient illuminance. Additionally, the concentration or light transmittance of the liquid material 53 may be inputted through the input device 140 or received from a server device that stores and manages information about the liquid product 50. In the process of acquiring spectral images for the liquid product 50, the shooting controller 151 may adjust the operating timing of the at least one spectral camera 101a, 101b and the at least one lighting device 102a, 102b in conjunction with the movement controller 152. For example, after acquiring the spectral image of a first line of the data cube 131 corresponding to the liquid product 50, the shooting controller 151 may request the movement controller 152 to move, and upon completion of the movement, perform controlling the at least one spectral camera 101a, 101b and the at least one lighting device 102a, 102b to acquire the spectral image of a second line adjacent to the first line. The shooting controller 151 may control movement and shooting repeatedly until all spectral images capable of constructing the data cube 131 corresponding to the liquid product 50 are acquired.

The movement controller 152 may control the movement of the at least one spectral camera 101a, 101b and the at least one lighting device 102a, 102b in conjunction with the shooting controller 151. For example, the movement controller 152 may collect current location information about the first movement support device 103a to which the first spectral camera 101a and the first lighting device 102a are fixed, and current location information about the second movement support device 103b to which the second spectral camera 101b and the second lighting device 102b are fixed. When receiving a movement request signal from the shooting controller 151, the movement controller 152 may control the movement of at least one of the first movement support device 103a and the second movement support device 103b. When the movement request of the shooting controller 151 ends, the movement controller 152 may control the first movement support device 103a and the second movement support device 103b to move to their initial positions. Meanwhile, although it is described that both the first and second movement support devices 103a and 103b are moved, the movement controller 152 may operate only one of the first and second movement support devices 103a and 103b when it is determined to acquire a spectral image of suspended matter or sediment depending on the characteristics or type of the liquid product 50.

The holder controller 153 may control the holder device 105 to fix or release the liquid product 50. For example, when the liquid product 50 is located in a space of the holder device 105, the holder controller 153 may control the holder device 105 to hold the liquid product 50. In this process, the holder controller 153 may adjust a gap of the holder device 105 in response to a user input. Alternatively, the holder controller 153 may include a related sensor to detect the liquid product 50 placed in the space of the holder devices 105 and automatically reduce the gap of the holder device 105 to hold the liquid product 50. In this process, using the sensor, the holder controller 153 may collect size information of the liquid product 50 and adjust the gap of the holder device 105 according to the size information.

The relationship matrix calculator 154 may calculate a relationship matrix based on the data cube 131 acquired by the at least one spectral camera 101a and 101b. In this process, the relationship matrix calculator 154 may decompose the data cube 131 by applying a sliding window to the data cube 131 (spectral image), split the decomposed window into pixel units, and calculate the relationship matrix between spectra in pixel units. The relationship matrix calculator 154 may include a similarity calculator 154a and a distance calculator 154b. The similarity calculator 154a may calculate similarity to determine the correlation between pixels in the process of calculating the relationship matrix. In one example, the similarity calculator 154a may calculate the cosine similarity between the reference spectrum and the control spectrum. The distance calculator 154b may calculate the distance between pixels using a matrix norm.

The graph calculator 155 may perform graph calculation based on at least one of the acquired data cube 131 and the relationship matrix calculated by the relationship matrix calculator 154. For example, the graph calculator 155 may derive a latent representation vector for each window of the data cube 131 (e.g., a patch window corresponding to certain regions of the data cube 131) by using a pre-trained model based on a spectral image (or data cube 131), pass through a connection block, and create a virtual node and representing the corresponding window. The graph calculator 155 may derive similarity by applying a cosine similarity and a distance function (e.g., Euclidean, Manhattan distance, etc.) between nodes, based on virtual nodes representing the respective windows decomposed from the data cube 131. In this process, the graph calculator 155 may use the similarity calculator 154a and the distance calculator 154b of the relationship matrix calculator 154 in relation to the above-described similarity and distance calculation. The graph calculator 155 uses the derived similarity as an edge between nodes, and at this time, the edge plays a role of connecting nodes in graph theory. The larger the edge value, the higher the connectivity between nodes, and the smaller the edge value, the lower the connectivity.

When the liquid product 50 contains a foreign matter, data in a region where the foreign matter is located is sparse compared to a region without the foreign matter, so it may contain a smaller amount than a normal region without the foreign matter. Therefore, the foreign matter determinator 156 may detect the foreign matter based on the distance between nodes indicating normality. In this process, the foreign matter determinator 156 may apply techniques such as graph theory-based GNN (Graph Neural Networks), cluster analysis, machine learning such as K-NN, deep learning such as CNN (Convolutional Neural Networks), etc. Meanwhile, although a binary classification model for distinguishing a normal state and a foreign matter state (or a normal region and a foreign matter region) is described, the present disclosure is not limited to this description. Alternatively, if there are various substances in learning data and it is necessary to classify them all, the foreign matter determinator 156 may prepare a categorical classification model and distinguish normal regions (e.g., regions where liquids smaller than a specified size are distributed, or regions where crystals of a specified size are considered normal) and various foreign matter regions (e.g., suspended matter region, sediment region), based on the categorical classification model. The foreign matter determinator 156 may perform foreign matter determination based on the characteristics of the relationship matrix. For example, the foreign matter determinator 156 may acquire the correlation value of pixels in the relationship matrix calculation process by requesting the similarity calculator 154a and perform foreign matter determination based on the correlation value. In relation to correlation calculation, the similarity calculator 154a or the distance calculator 154b may calculate the similarity or distance between the reference spectrum and the control spectrum and provide the result to the foreign matter determinator 156. The foreign matter determinator 156 may identify the received calculated values and determine that a pixel showing a similarity or distance value greater than a reference value is a foreign matter point. Alternatively, the foreign matter determinator 156 may receive the distance calculation value between nearest neighbors (or nearest pixels) using the nearest neighbor method (K-nearest neighbor method) from the distance calculator 154b, and perform the foreign matter determination based on the received the distance calculation value.

Additionally or alternatively, the control device 150 of the foreign matter management device 100 may support the creation and operation of a learning model in relation to foreign matter determination for the liquid product 50. In this regard, the control device 150 may collect a given number of data cubes or more related to various liquid products 50, and when the number of collections is greater than or equal to a certain number, perform machine learning on the data cubes to create at least one of a learning model for the data cube in the normal state, a learning model for the liquid substance region in the normal state, a learning model for the foreign matter region, and a learning model based on the relationship matrix obtained from the data cubes. In the above-described learning model creation process, the control device 150 of the foreign matter management device 100 may pre-obtain labeling information (e.g., normal data or data containing foreign matter) for data for generating a learning model (e.g., at least one of data cubes and relationship matrices) or input labeling information through a user input. The control device 150 may perform at least one of supervised learning and unsupervised learning in relation to generating at least one learning model described above. For example, in the case of a machine learning model, the control device 150 may perform learning based on K-nearest neighbor, and in the case of a deep learning model, the control device 150 may selectively use one or more of fully-connected, convolution, recurrent, graph, and transformer when configuring a discriminator based on supervised learning or a generator based on unsupervised learning. However, the model generation method of the present disclosure is not limited to the specific method described above, and various modifications or new model generation methods may be applied.

As described above, the foreign matter management device 100 according to the first embodiment of the present disclosure can divide the data cube using a sliding window scheme (or patch window scheme), generate the relationship matrix by determining the relationship between spectra included in the divided data cube 131, and determine the occurrence or not of foreign matter by using the relationship matrix. Alternatively, the foreign matter management device 100 may graph the data cube 131 to determine the point and type of the foreign matter. In the case of the RGB camera, the colors of scratches and foreign matter may be displayed very similarly, but the present disclosure, which utilizes the characteristics of the spectral camera that decomposes and captures images into high-resolution wavelengths, can support more accurate determination because of comparing information on scratches and foreign matter in spectral units. Additionally, the present disclosure can locally transform the data cube 131 (image captured using the spectral camera) using a sliding window (or patch window), and can identify foreign matter points and support foreign matter type determination by converting to a graph structure as needed or selectively. Considering that the resolution of the data cube 131 is very high compared to RGB images, etc., powerful computing resources are required to convert the entire data cube 131 into a graph at once. However, if performing local graph conversion and merging, computing resources can be saved when converting each local region into a graph. If the region to be divided with a sliding window (or patch window) is extracted in advance and processed in parallel, the overall processing time can be greatly reduced.

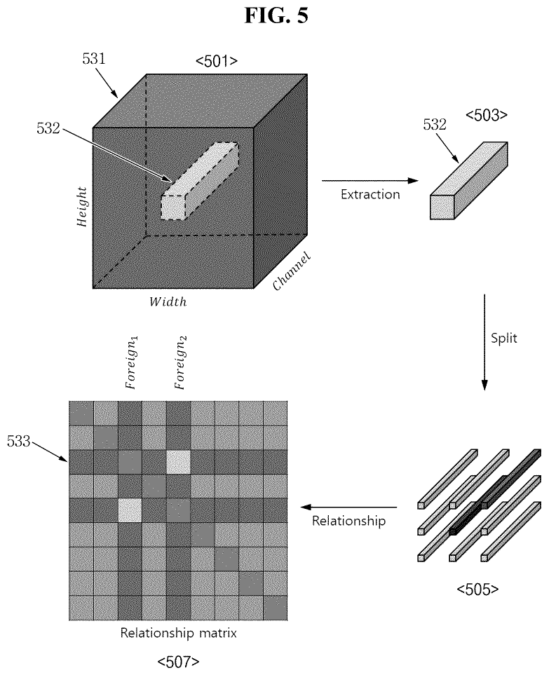

FIG. 4 is a block diagram illustrating a management server device according to the first embodiment of the present disclosure. As described above, if the foreign matter management device 100 is designed to independently support the foreign matter management function for liquid products, the management server device 200 may be omitted.

Referring to FIG. 4, the management server device 200 may include a server communication circuit 210, a server memory 230, a server input unit 240, a server display 260, and a server processor 250. When the foreign matter management device 100 is configured to collect and transmit spectral images for the liquid product 50, the management server device 200 may be configured to process the spectral images and determine foreign matter.

The server communication circuit 210 may establish a communication channel with the foreign matter management device 100 through the network 20 or directly. The server communication circuit 210 may collect a plurality of spectral images and a current spectral image from the foreign matter management device 100 in response to a designated period or the occurrence of a predefined event. Alternatively, the server communication circuit 210 may receive a data cube corresponding to the liquid product 50 from the foreign matter management device 100.

The server memory 230 may store at least one program or data necessary for the operation of the management server device 200. For example, the server memory 230 may store a data cube 231 generated based on a plurality of spectral images provided by the foreign matter management device 100, and a relationship matrix 233 generated based on analysis of respective pixels obtained by decomposing the data cube 231 with a window of a specified size (e.g., a slide window or a patch window). Additionally, the server memory 230 may store at least one learning model (e.g., a machine learning model or a deep learning model) generated based on at least one of a given number or more of data cubes and relationship matrices.

The server input unit 240 may include mechanisms for receiving various administrator's (or user's) inputs necessary for the operation of the management server device 200. For example, the server input unit 240 may include at least one of a keyboard, a keypad, a touch pad, a touch screen, a jog shuttle, a wheel, and a voice input device. The server input unit 240 may create at least one of an input signal requesting connection with the foreign matter management device 100, an input signal requesting acquisition of a spectral image for the liquid product 50, and an input signal requesting a foreign matter determination result for the liquid product in response to an administrator's input, and transmit the created input signal to the server processor 250.

The server processor 250 may control the transmission and processing of signals required for the operation of the management server device 200, and the storage, transmission, or output of processing results. The server processor 250 may control various procedures required for the analysis of collected spectral images and foreign matter determination. In one example, the server processor 250 may include at least some of the relationship matrix calculator 154, the graph calculator 155, and the foreign matter determinator 156, which are previously described in FIG. 3, and perform foreign matter determination based on these components. The server processor 250 may output the foreign matter determination result on the server display 260 or transmit a message including the foreign matter determination result to a designated portable terminal.

FIG. 5 is a diagram illustrating the creation of a relationship matrix according to the first embodiment of the present disclosure. Hereinafter, it will be descried for example that the foreign matter management device 100 generates a relationship matrix. However, the present disclosure is not limited to this example, and the management server device 200 may also perform relationship matrix calculation.

Referring to FIGS. 1 to 5, in the process of acquiring a spectral image of the liquid product 50 through the at least one spectral camera 101a, 101b, the foreign matter management device 100 may acquire the spectral image for the liquid product 50 using a pushbroom scanning scheme and generate the data cube 531 as in a state 501. The data cube 531 may be created in the process of acquisition by the at least one spectral camera 101a, 101b. Alternatively, the control device 150 (e.g., relationship matrix calculator 154) of the foreign matter management device 100 may generate the data cube 531 based on spectral images acquired using the pushbroom scanning scheme. In another example, the foreign matter management device 100 may collect spectral images for each patch window size for the liquid product 50 and generate the data cube 531 by combining the collected spectral images. In the data cube 531 shown in the state 501, a foreign matter-containing region 532 may exist.

The foreign matter management device 100 may extract the foreign matter-containing region 532 included in the data cube 531 as in a state 503. In this process, the foreign matter management device 100 may extract, as the foreign matter-containing region 532, a certain region where foreign matter is likely to occur. Alternatively, the foreign matter management device 100 may empirically or statistically extract, as the foreign matter-containing region 532, a region where foreign matter is likely to occur. Alternatively, the foreign matter management device 100 may define the foreign matter-containing region 532 in a specified manner for the data cube 531.

After extracting the foreign matter-containing region 532, the foreign matter management device 100 may split the foreign matter-containing region 532 into predefined specific region units as in a state 505. For example, the foreign matter management device 100 may split a portion (i.e., window) of the data cube 531 extracted with a sliding window into pixel units (each pixel corresponds to a spectrum). The foreign matter management device 100 may calculate a relationship matrix 507 between spectra split in pixel units as in a state 507. In the calculated relationship matrix 507, a pixel corresponding to a foreign matter shows a low correlation (a correlation coefficient of low magnitude) compared to the other pixels. Using this feature, the foreign matter management device 100 may calculate the pixel of low correlation with surrounding information. At this time, a method of calculating the correlation may utilize a similarity calculation formula such as cosine similarity between the reference spectrum and the control spectrum. Alternatively, the foreign matter management device 100 may use a distance function such as matrix norm. In the case of using the matrix norm, the foreign matter management device 100 may determine a pixel that is far away from the other pixels (or has a high distance magnitude), as a foreign matter point. However, in the present disclosure, there are no restrictions on detailed function changes when measuring the similarity or distance. Alternatively, the foreign matter management device 100 may selectively utilize a method of calculating only the distance to the nearest neighbor using the K-nearest neighbor method.

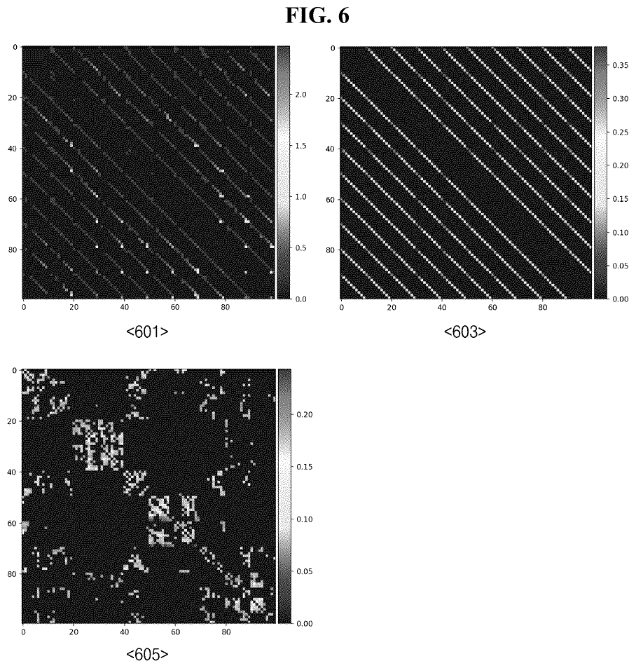

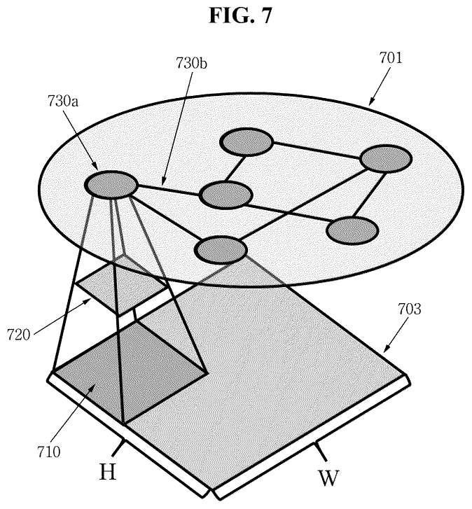

FIG. 6 is a diagram illustrating the configuration of a relationship matrix according to the first embodiment of the present disclosure.

Referring to FIGS. 1 to 6, the foreign matter management device 100 may calculate the distance to the nearest neighbor using the upper K-nearest neighbor method and construct a relationship matrix. For example, the foreign matter management device 100 may provide a relationship matrix 601 calculated in designated window units for a data cube based on spectral images corresponding to a normal portion of the liquid product 50. Additionally, the foreign matter management device 100 may provide a relationship matrix 603 calculated in another window corresponding to a normal portion of the liquid product 50. Additionally, the foreign matter management device 100 may provide a relationship matrix 605 calculated in a window corresponding to a foreign matter region of the liquid product 50. In such relationship matrices, each of the x-axis (or the horizontal axis in the drawing) and the y-axis (or the vertical axis in the drawing) denotes the number of a node. For example, in the relationship matrix, information at the (20, 30) point may include distance information between the reflectances of the K nearest wavelength bands in the wavelength band information of the 20th node (or spectrum) and the 30th node (or spectrum). Comparing the relationship matrices 601, 603, and 605, it can be seen that the relationship matrices 601 and 603 calculated in the window corresponding to a normal portion clearly appear as diagonal matrices. On the other hand, the relationship matrix 605 calculated in the window for the foreign matter region shows a clumping area around diagonal elements. That is, in the relationship matrix 605, it can be seen that information that is foreign matter or suspicious for foreign matter exists in a bundle inside the window. Based on the characteristics compared among the relationship matrices 601, 603, and 605, the foreign matter management device 100 may detect the presence or not of foreign matter and classify the type of foreign matter.

FIG. 7 is a diagram illustrating a graph calculation according to the first embodiment of the present disclosure. Hereinafter, it will be described as an example that the foreign matter management device 100 performs the graph calculation. However, the present disclosure is not limited to this example, and the management server device 200 may also perform the graph calculation.

Referring to FIGS. 1 to 7, the foreign matter management device 100 may construct a graph based on the relationship matrix and spectrum data previously described in FIG. 5. In the process of constructing the graph, the foreign matter management device 100 may calculate the graph by applying a node (or vertex, spectrum) corresponding to each pixel and an edge corresponding to each similarity (or distance) of the relationship matrix. Here, the relationship matrix may correspond to an adjacency matrix.

In relation to graph calculation, the foreign matter management device 100 may acquire an image field 703. The image field 703 may be, for example, at least a portion of the data cube 531. The image field 703 may include a region of height (H) and width (W). For example, when His 16 and W is 16, the image field 703 may be a region containing a 16×16 image. A patch block 710 (or patch window) and a connection block 720 may perform the role of transmitting an image existing in the image field 703 to a virtual node field 701 through a convolutional operation between the image and the filter in the image field 703.

In the drawing, the virtual node field 701 refers to a region containing a graph structure composed of a node 730a and an edge 730b. The foreign matter management device 100 may create the virtual node 730a for the window in the virtual node field 701 based on the value calculated in the image field 703, and create a graph based on the created virtual nodes 730a.

In one example, the foreign matter management device 100 may derive a latent representation vector for each window by using an image-based pre-trained model, pass through the connection block 720, and generate the virtual node 730a representing the corresponding window. The foreign matter management device 100 may derive similarity by applying a cosine similarity and a distance function (e.g., Euclidean, Manhattan distance, etc.) between the nodes 730a, based on the virtual nodes 730a representing the respective windows, and use the derived similarity as the edge 730b. In this process, the edge 730b serves as a connection between the nodes 730a in graph theory. The larger the edge value, the higher the connectivity between nodes, and the smaller the edge value, the lower the connectivity. Because data in a region corresponding to the foreign matter is very sparse, the amount is less than that in the normal region, and the foreign matter can be detected based on the distance between nodes indicating normality. In relation to foreign matter calculation, the foreign matter management device 100 may apply techniques such as graph theory-based GNN (Graph Neural Networks), cluster analysis, machine learning such as K-NN, deep learning such as CNN (Convolutional Neural Networks), etc. In relation to the foreign matter determination, the trained model may use a binary classification model that distinguishes between normal and foreign matters, and if there are various substances in the learning data and it is necessary to distinguish them, a categorical classification model may be applied.

As described above, the foreign matter management device 100 can provide a method of detecting a foreign matter region through graph theory in the data cube acquired from spectral images of the liquid product 50 (or liquid substance contained in the liquid product 50). In this regard, the foreign matter management device 100 can explore the entire patch window (or patch area) of a certain size or more by sliding it on the data cube, construct data existing inside or outside the window as the node 730a, and form the relationship matrix by setting the relationship between the nodes 730a as the edge 730b. In the above-described node creation process, the foreign matter management device 100 may apply a method of mapping a window (or patch window, or patch area) of a specific size into one or more virtual nodes. For example, in relation to the method of creating the virtual node, the foreign matter management device 100 may use machine learning such as linear regression or deep learning such as CNN (Convolutional Neural Networks) or apply at least one of methods for expressing as a basic statistic of the window. The foreign matter management device 100 may determine a foreign matter by calculating the similarity between the nodes 730a with reference to the calculated virtual node, and the similarity may be set with various functions such as cosine similarity, Euclidean distance, etc. In relation to the process of providing a machine learning or deep learning-based artificial intelligence model based on the virtual node, the foreign matter management device 100 may form the relationship matrix based on the calculated virtual node and provide an artificial intelligence model based on graph theory, or provide a learning model based on unsupervised learning such as K-nearest neighbors using the calculated virtual node.

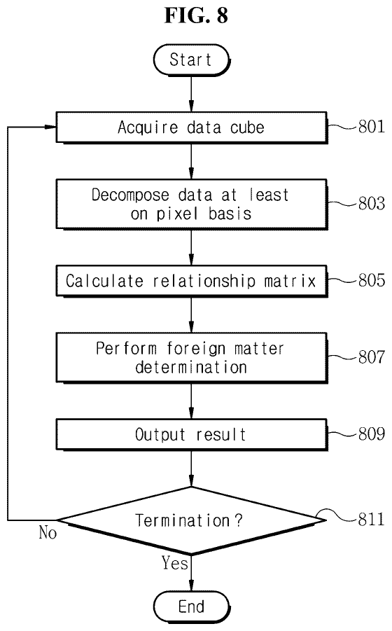

FIG. 8 is a flowchart illustrating a foreign matter management method for a liquid product according to the first embodiment of the present disclosure. Hereinafter, it will be described that the foreign matter management device performs the foreign matter management method for a liquid product, but the present disclosure is not necessarily limited thereto. The foreign matter management method for a liquid product described below may be performed by the management server device.

Referring to FIGS. 1 to 8, in relation to the foreign matter management method for liquid products, the control device 150 (or processor) of the foreign matter management device 100 may acquire a data cube in step 801. In this regard, the foreign matter management device 100 may collect spectral images for the liquid product 50 by controlling the at least one spectral camera 101a, 101b arranged to photograph the liquid product 50 mounted on the holder device 105. In this process, the control device 150 may collect spectral images for respective portions of the liquid product 50 and then combine the collected spectral images to generate a data cube for the liquid product 50. Alternatively, the data cube may be generated while the at least one spectral camera 101a, 101b partially captures spectral images regarding the liquid product 50.

In step 803, the control device 150 of the foreign matter management device 100 may perform data decomposition at least on a pixel basis. For example, the control device 150 may decompose the data cube into pixel units (having the same meaning as spectrum units) in each window created through a sliding window, and then acquire decomposed pixels. In this regard, rather than decomposing the entire data cube into at least one pixel unit, it is possible to determine a region of a certain size as a pixel-unit decomposition region. To this end, the control device 150 may perform data cube search. For example, the control device 150 of the foreign matter management device 100 may search the entire or part of the data cube with a sliding window of a certain size or more specified by the user, or set the sliding window as a hyper-parameter within the algorithm, automatically select the optimal sliding window, and explore all or part of the data cube. In the data cube decomposition, the control device 150 of the foreign matter management device 100 may determine the number of pixels to be decomposed differently depending on the size of the data cube or computing capacity (or performance). When a plurality of pixels are determined, the control device 150 may decompose the data cube into a plurality of pixel groups.

In step 805, the control device 150 of the foreign matter management device 100 may calculate a relationship matrix based on the decomposed pixels. For example, the control device 150 may calculate the relationship matrix by measuring the similarity or distance between respective pixels in the calculated decomposed pixels. In relation to similarity calculation, the control device 150 may set a basic function to cosine similarity, but does not place restrictions on changing the similarity function or changing parameter settings. In relation to distance calculation, the control device 150 may set a basic function to Euclidean weight-based distance calculation, but there are no restrictions on changing the distance function or changing parameter settings.

In step 807, the control device 150 of the foreign matter management device 100 may perform foreign matter determination based on the relationship matrix. In one example, the control device 150 may determine a foreign matter based on relationships with other pixels within each window in the calculated relationship matrix. For example, the control device 150 may set one or more pixels that are determined to be foreign matters in the window. In determining a foreign matter, the control device 150 may determine a foreign matter if a similarity or distance value that deviates from a rule or range specified by the user is detected. Additionally, at the user's request, the foreign matter management device 100 may provide a machine learning or deep learning-based artificial intelligence model that determines whether there is a foreign matter based on the relationship matrix.

In step 809, the control device 150 of the foreign matter management device 100 may output a foreign matter determination result. In this regard, the foreign matter management device 100 may further include a separate display, and the control device 150 may output the foreign matter determination result of the liquid product 50 to the display. Alternatively, the control device 150 may transmit the foreign matter determination result as a message to a pre-designated user terminal (or administrator terminal).

In step 811, the control device 150 of the foreign matter management device 100 may check whether an event related to termination occurs. For example, when mounting of the additional liquid product 50 does not occur for a certain period of time, the control device 150 may determine that the termination-related event occurs. Also, when a termination-related user input occurs, the control device 150 may determine this input as the termination-related event. If no termination-related event occurs or if a new liquid product 50 is mounted in the holder device 105, the control device 150 may return to the step 801 and re-perform the subsequent operations.

Meanwhile, in relation to acquiring the data cube about the liquid product, the control device 150 of the foreign matter management device 100 may control the shooting method of the spectral camera differently depending on the type or characteristics of the liquid product 50. In one example, the foreign matter management device 100 may selectively configure one or more of a shooting method for inspecting sediments or a shooting method for inspecting suspended matter. In relation to the sediment inspection, the foreign matter management device 100 may acquire a spectral image of the liquid product 50 in an upward shooting direction. In relation to the suspended matter inspection, the foreign matter management device 100 may acquire a spectral image of the liquid product 50 in a downward shooting direction. Therefore, the foreign matter management device 100 can minimize the light refraction phenomenon of the liquid material 53 and obtain a spectral image that captures the shape of the foreign matter (e.g., sediment or suspended matter) more clearly.

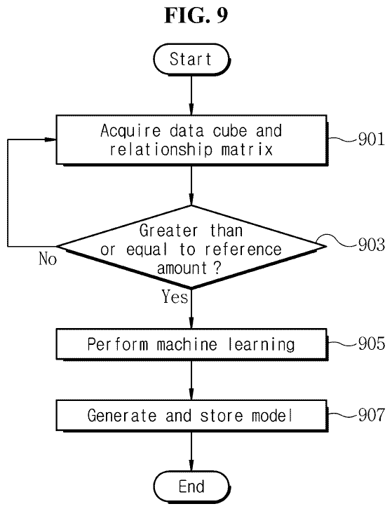

FIG. 9 is a flowchart illustrating a model operation related to the foreign matter management method for a liquid product according to the first embodiment of the present disclosure.

Referring to FIG. 9, in relation to the foreign matter management method for a liquid product, the control device 150 of the foreign matter management device 100 may perform acquisition of a data cube and a relationship matrix in step 901. Acquiring the data cube and the relationship matrix may include the steps 801 to 805 described above with reference to FIG. 8.

In step 903, the control device 150 of the foreign matter management device 100 may check whether the quantity of data cubes and relationship matrices is greater than or equal to a reference amount. If the quantity is less than the reference amount, the control device 150 may return to the step 901 and re-perform the subsequent operations to obtain the data cubes and relationship matrices greater than the reference amount.

If the quantity of data cubes and relationship matrices is greater than or equal to the reference amount, the control device 150 of the foreign matter management device 100 may perform machine learning in step 905. Next, in step 907, the control device 150 may generate and store a model as the result of machine learning. In one example, the control device 150 may perform foreign matter determination based on the relationship matrix based on similarity or distance values between pixels of the relationship matrix, and classify data containing foreign matter (e.g., data cube and relationship matrix containing foreign matter) and data not containing foreign matter (e.g., data cube and relationship matrix without foreign matter). The control device 150 may perform supervised learning (e.g., learning based on data containing foreign matter and data without foreign matter) according to the classification, and generate a learning model including foreign matter and a learning model without foreign matter according to supervised learning. Alternatively, the control device 150 may perform unsupervised learning using data cubes and relationship matrices without foreign matter and generate a learning model according to unsupervised learning.

In one example, the control device 150 may generate a machine learning or deep learning-based artificial intelligence model using one or more of the relationship matrix and the data cube. In providing a machine learning or deep learning model, the control device 150 may operate one or more of a supervised learning method and an unsupervised learning method. In the case of the machine learning model, the control device 150 may operate the K-nearest neighbor method. In the case of the deep learning model, the control device 150 may selectively use one or more of fully-connected, convolution, recurrent, graph, and transformer in constructing a discriminator based on supervised learning and a generator based on unsupervised learning.

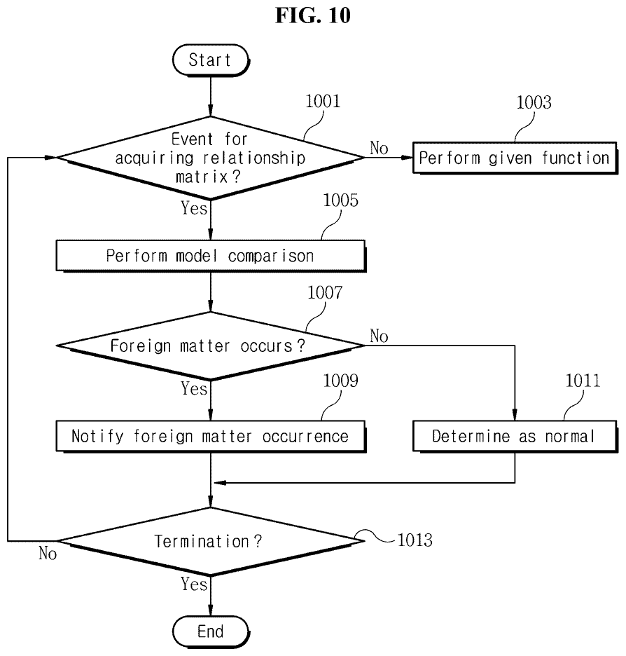

FIG. 10 is a flowchart illustrating a foreign matter determination method in the foreign matter management method for a liquid product according to the first embodiment of the present disclosure.

Referring to FIG. 10, in relation to the foreign matter management method for a liquid product, the control device 150 of the foreign matter management device 100 may check in step 1001 whether any occurring event is a relationship matrix acquisition event. For example, after a spectral image for the liquid product 50 is acquired through the at least one spectral camera 101a, 101b, and a data cube is generated based on the acquired spectral image, the relationship matrix may be acquired through the above-described steps 801 to 805 of FIG. 8. If the occurring event is not related to acquiring the relationship matrix, the control device 150 may perform a given function according to the event in step 1003. For example, the control device 150 may support a foreign matter management function for the liquid product 50. In one example, the control device 150 may output a foreign matter determination result for a previously inspected liquid product, or may output a foreign matter management history in response to a user's input. Additionally or alternatively, the control device 150 may receive at least one learning model (or artificial intelligence model) related to foreign matter determination from an external server device in response to a user's input and store it in the memory 130.

If the occurring event is a relationship matrix acquisition event, the control device 150 may perform model comparison in step 1005. In this regard, the foreign matter management device 100 may store and manage a learning model for comparison with the currently acquired relationship matrix in the memory 130. For the model comparison with the currently acquired relationship matrix, if there is no learning model stored in the memory 130, the control device 150 may receive a related learning model from an external server device and store it in the memory 130. Alternatively, as previously described with reference to FIG. 9, the control device 150 may acquire a learning model by generating the learning model for at least one of the data cubes and the relationship matrices obtained greater than the reference amount, and store the acquired learning model in the memory 130.

In step 1007, the control device 150 may determine whether a foreign matter occurs, based on the model comparison result. For example, the control device 150 may acquire the learning model for a relationship matrix containing no foreign matter from the memory 130, compare it with the current relationship matrix, and determine the occurrence or not of foreign matter occurs based on the similarity. Alternatively, the control device 150 may acquire the learning model containing a foreign matter from the memory 130, compare it with the current relationship matrix, and determine the occurrence or not of foreign matter based on the similarity.

If the occurrence of foreign matter is confirmed, in step 1009, the control device 150 may process a notification of the occurrence of foreign matter. For example, if the similarity is less than the reference value in comparing the current relationship matrix with the learning model containing no foreign matter, the control device 150 may determine that the current relationship matrix includes foreign material. Alternatively, if the similarity is greater than or equal to the reference value in comparing the current relationship matrix with the learning model containing foreign matter, the control device 150 may determine that the current relationship matrix includes the foreign matter. If it is determined that the relationship matrix contains a foreign matter, the control device 150 may output information indicating that the liquid product 50 corresponding to the relationship matrix contains a foreign matter through an output device such as a display or send a message to the administrator terminal.

If no foreign matter occurs, in step 1011, the control device 150 may determine normality and perform subsequent processing accordingly. For example, if the similarity is greater than or equal to a reference value in comparing the current relationship matrix with the learning model containing no foreign matter, the control device 150 may determine that the current relationship matrix does not include the foreign matter. Alternatively, if the similarity is less than the reference value in comparing the current relationship matrix with the learning model containing foreign matter, the control device 150 may determine that the current relationship matrix does not include the foreign matter. If it is determined that the relationship matrix does not contain foreign matter, the control device 150 may determine that the liquid product 50 corresponding to the relationship matrix is a normal product that does not contain foreign matter, and notify the related result or skip separate notification.

Next, in step 1013, the control device 150 may check whether a termination event occurs. The termination event may include a user input requesting the termination of foreign matter determination. Additionally or alternatively, the termination event may include a case where a predefined period of time has elapsed without a request for inspection of a new liquid product 50. If no termination event occurs, the control device 150 may return to the step 1001 and re-perform the subsequent operations.

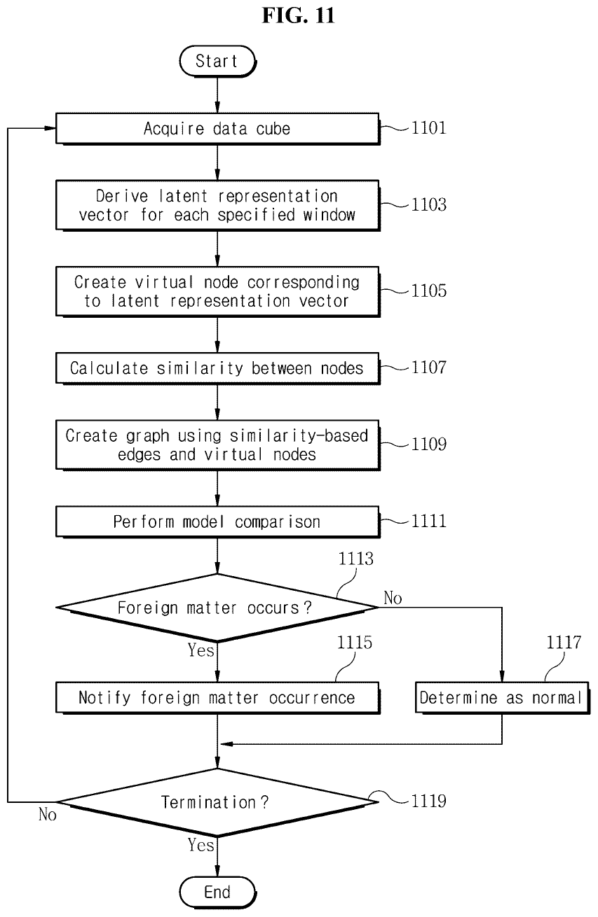

FIG. 11 is a flowchart illustrating a foreign matter determination based on a graph in the foreign matter management method for a liquid product according to the first embodiment of the present disclosure.

Referring to FIG. 11, in relation to the foreign matter management method for a liquid product, the control device 150 of the foreign matter management device 100 may acquire a data cube in step 1101. In relation to this, the control device 150 may acquire the data cube stored in the memory 130. The data cube may be generated, for example, by spectral images acquired by at least one spectral camera.

In step 1103, the control device 150 may derive a latent representation vector for each designated window, and in step 1105, the control device 150 may create a virtual node corresponding to the latent representation vector. For example, the control device 150 may acquire an image field of a certain region for the data cube and allocate a patch window of a predefined size to the acquired image field. The size of the patch window may vary depending on the size of the image field. The control device 150 may calculate a latent representation vector for respective pixels arranged in the patch window. In this process, the control device 150 may apply a connection block for calculating a representative value for the patch window, calculate the latent representation vector based on the calculated representative value, and allocate a virtual node corresponding to it. In one example regarding virtual node allocation, the control device 150 may allocate a virtual node using the method previously described in FIG. 7. In another example, as previously shown in FIG. 7, the control device 150 may slide and search the entire data cube (or at least part of it) in units of windows (e.g., patch blocks or patch windows) of a certain size or more, and allocate data existing inside or outside the nodes as virtual nodes (or nodes). The control device 150 may allocate the virtual nodes by mapping representative values of each window of a specific size into the virtual nodes. Alternatively, the control device 150 may allocate the virtual node using at least one of a machine learning method including linear regression, a deep learning method including a CNN (Convolutional Neural Networks) method, and a method for expressing as basic statistics for each window.

In step 1107, the control device 150 may calculate similarity between nodes. In this process, the control device 150 may detect similarity by applying a cosine similarity function to the nodes. Alternatively, the control device 150 may calculate a distance value instead of calculating the similarity between nodes, and at this time, it may apply the Euclidean distance function.

In step 1109, the control device 150 may create a graph using similarity-based edges and virtual nodes. For example, the control device 150 may divide the image field into a plurality of patch windows, convert representative values of the respective patch windows into virtual nodes, and then create a graph corresponding to the image field based on applying the similarity (or distance value) between the nodes. Additionally or alternatively, the control device 150 may generate a relationship matrix based on the nodes and edges.

In step 1111, the control device 150 may compare the pre-stored model with the graph corresponding to the currently acquired data cube. For example, the pre-stored model may include a graph model corresponding to an image field that does not contain foreign matter. Alternatively, the pre-stored model may include a graph model corresponding to the foreign matter-containing image field. In step 1113, the control device 150 may check whether foreign matter occurs, based on the comparison result. In the model comparison process, the control device 150 may compare the current graph corresponding to the current data cube with a pre-stored graph model to determine whether it is within a specified reference value range.

If there is a foreign matter as a result of the comparison, the control device 150 may notify the occurrence of the foreign matter in step 1115. In one example, when comparing a foreign matter-containing graph model and the current graph, the control device 150 may determine the current graph to be a foreign matter-containing graph if the similarity is greater than a reference value. Alternatively, when comparing the graph model without foreign matter and the current graph, the control device 150 may determine the current graph to be a graph containing foreign matter if the similarity is less than a reference value. In another example, when comparing a graph model containing foreign matter and the current graph, the control device 150 may determine the current graph to be a graph without foreign matter if the similarity is less than a reference value. Alternatively, when comparing the graph model without foreign matter and the current graph, the control device 150 may determine the current graph to be a graph without foreign matter if the similarity is higher than a reference value. In relation to foreign matter notification, the control device 150 may output the foreign matter determination result of the current graph to an output device (e.g., display) provided in the foreign matter management device 100. Additionally or alternatively, the control device 150 may provide an alarm about the occurrence of a foreign matter to a designated manager terminal.

If no foreign matter occurs as a result of the comparison, the control device 150 may perform processing according to the normal determination in step 1117. For example, the control device 150 may output at least one of a prearranged color, message, beep sound, guidance text, or voice indicating a normal determination.

In step 1119, the control device 150 may check whether a termination event related to foreign matter determination occurs. If no termination event occurs, the control device 150 may return to the step 1101 and re-perform the subsequent operations. When a termination event occurs, the control device 150 may end the foreign matter determination procedure for the liquid product 50.

In the above-described operation, the control device 150 may construct the graph by including the relationship matrix and each pixel (or spectrum) information involved in forming the relationship matrix as a node, and construct the graph in sliding window units. In relation to foreign matter determination, the control device 150 may detect nodes containing foreign matter based on the density between nodes in the graph, and the density between nodes may be determined by, for example, the similarity or distance value obtained from the relationship matrix. In one example, the control device 150 may perform an optimization method such as linear search to automatically calculate the optimal reference value in response to a user input, and when a pattern that deviates from a reference value given by a user input or predetermined is detected, determine as the occurrence of foreign matter.

Additionally or alternatively, the control device 150 may generate and provide at least one artificial intelligence model based on machine learning or deep learning using the virtual nodes (or nodes) in response to a user input. The control device 150 may form a relationship matrix based on the calculated virtual nodes and provide an artificial intelligence model based on graph theory. Additionally, the control device 150 may generate and provide an artificial intelligence model based on unsupervised learning such as K-nearest neighbors based on the calculated virtual nodes. In another example, the control device 150 may generate an artificial intelligence model based on machine learning or deep learning based on the virtual nodes in response to a user input, generate a relationship matrix based on the virtual nodes and generate an artificial intelligence model based on graph theory, or generate an artificial intelligence model corresponding to the virtual nodes based on unsupervised learning including the K-nearest neighbors method.

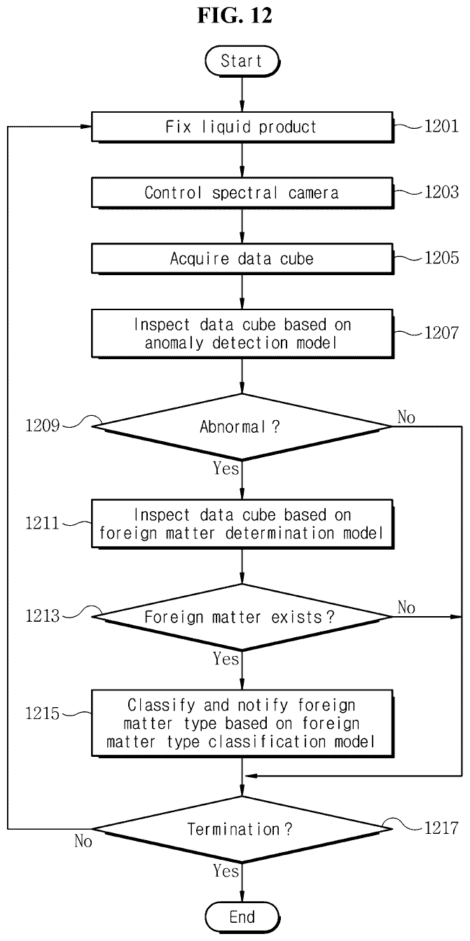

FIG. 12 is a flowchart illustrating a foreign matter determination through multi-stage model operation in the foreign matter management method for a liquid product according to the first embodiment of the present disclosure.

Referring to FIG. 12, in relation to the foreign matter management method for a liquid product, when the liquid product 50 is mounted in the holder device 105, the control device 150 of the foreign matter management device 100 may identify the mounting state of the liquid product 50 and fix the liquid product 50 in step 1201. In this regard, the control device 150 may identify the mounting of the liquid product 50 upon a sensor signal from a sensor unit disposed within the holder device 105 including two or more arms. Once the liquid product 50 is identified to be mounted, the control device 150 may fix the liquid product 50 by controlling the arms of the holder device 105. Additionally or alternatively, the control device 150 may adjust the arrangement direction of at least one arm to be in a predefined direction in which the liquid product 50 is fixed.

When the liquid product is fixed to the holder device 105, the control device 150 may control at least one spectral camera to acquire a spectral image of the liquid product 50 in step 1203. In this operation, the control device 150 may control spectral image capture from the top to the bottom of the liquid product 50 or from the bottom to the top of the liquid product 50, depending on the type of the liquid product 50 or a user input.

In step 1205, the control device 150 may acquire a data cube corresponding to spectral images for the liquid product 50. In this regard, the control device 150 may generate the data cube by combining windows (or spectral images) sequentially acquired for at least one side of the liquid product 50 while the spectral camera moves.

In step 1207, the control device 150 may inspect the data cube based on an anomaly detection model and, in step 1209, determine whether there is an abnormality. In this regard, the foreign matter management device 100 may pre-store the anomaly detection model. For example, the anomaly detection model may include a detection model generated through unsupervised learning for data cubes that have been determined to be normal. The control device 150 applies the currently acquired data cube to the anomaly detection model generated based on data cubes determined to be normal, and check whether a similarity value within a predefined reference range is detected. If a similarity value is detected within a predefined reference range, the control device 150 may determine that the liquid product 50 is normal, notifies this, and proceed to step 1217. Meanwhile, the anomaly detection model may include a detection model created based on abnormal data cubes. In this case, the control device 150 may determine abnormality as the similarity between the current data cube and the detection model increases.

The control device 150 may determine abnormality when a similarity value is detected outside a predefined reference range. In this case, the control device 150 may perform a data cube inspection based on a foreign matter determination model in step 1211 and check whether a foreign matter exists in step 1213. In this regard, the control device 150 may pre-store the foreign matter determination model in the memory 130. The foreign matter determination model may include a model that requires larger calculations than the anomaly detection model. Alternatively, the foreign matter determination model may include a model that can determine where the foreign matter exists in the data cube compared to the anomaly detection model. If it is determined that no foreign matter exists based on comparison with the foreign matter determination model or application of the foreign matter determination model, the control device 150 may perform notification of the absence of the foreign matter and proceed to step 1217.

If it is determined that a foreign matter exists, the control device 150 may classify the type of the foreign matter based on a foreign matter type classification model in step 1215 and process related notification. In this regard, the foreign matter management device 100 may store at least one foreign matter type classification model. For example, the foreign matter type classification model may include a plurality of classification models for various types of foreign matters that can be detected in the liquid product 50. The control device 150 may detect a foreign matter region of the data cube and compare the detected foreign matter region with the plurality of classification models to determine the type of foreign matter.

Next, in step 1217, the control device 150 may check whether the foreign matter inspection for the liquid product 50 is terminated, and if no event related to the termination occurs, the control device 150 may return to the step 1201. In this process, the control device 150 may control the holder device 105 to release the fixed state of the liquid product 50 and move the inspection-completed liquid product 50 to a designated location. The termination event may include, for example, a case where a user input requesting the termination of foreign matter inspection occurs. Additionally or alternatively, the termination event may include a case where a predefined work time elapses.

Although it has been described for example that the comparison with models is performed based on the data cube, the present disclosure is not limited to this example. Alternatively, the foreign matter management device 100 may store the anomaly detection model, the foreign matter determination model, and the foreign matter type classification model for each of at least one of the relationship matrix and the graph, and perform foreign matter determination by applying the respective models to the relationship matrix or the graph step by step. Alternatively, if necessary, at least one of the anomaly detection model, the foreign matter determination model, and the foreign matter type classification model may be applied to at least one of the data cube, the relationship matrix, and the graph described above. In one example, when high accuracy is required for foreign matter determination, the control device 150 may apply the anomaly detection model, the foreign matter determination model, and the foreign matter type classification model to each of the data cube, the relationship matrix generated from the data cube, and the graphs generated using at least one of the data cube and the relationship matrix. In another example, when work speed improvement is required, only the anomaly detection model may be applied using the data cube for quick foreign matter determination. In still another example, for data storage management purposes, foreign matter determination may be performed by applying the graphs with relatively less data and corresponding models, and the results may be stored and managed for each graph.

### Second Embodiment

Hereinafter, a foreign matter detection support system according to the second embodiment of the present disclosure will be described.

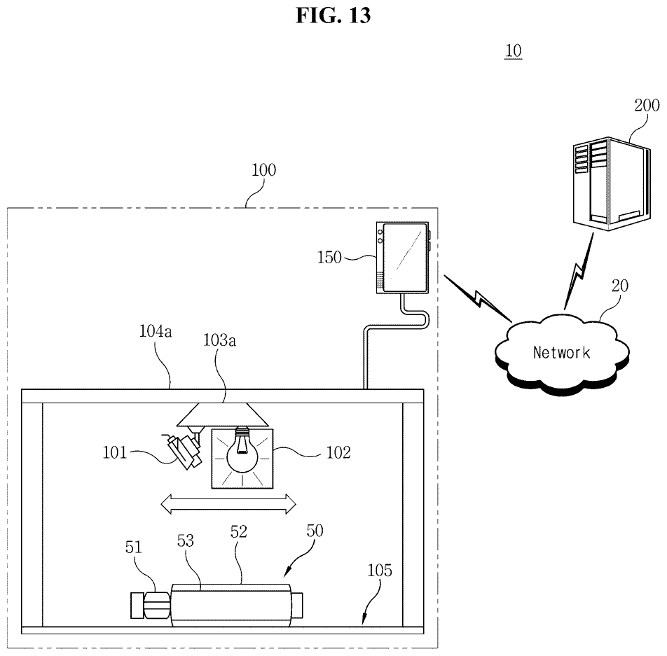

FIG. 13 is a schematic diagram illustrating a foreign matter detection support system according to the second embodiment of the present disclosure.

Referring to FIG. 13, the foreign matter detection support system 10 may include a product 50, a foreign matter detection support device 100, a network 20, and a foreign matter management server device 200. In this embodiment, the foreign matter detection support system 10 uses the network 20 for communication between the foreign matter detection support device 100 and the foreign matter management server device 200, but the present disclosure is not limited to this embodiment. Alternatively, the foreign matter detection support device 100 and the foreign matter management server device 200 may be connected via a wireless communication channel using a base station or may be directly connected through a wired cable. When the foreign matter detection support device 100 and the foreign matter management server device 200 are directly connected via a wired cable, or when the foreign matter detection support device 100 and the foreign matter management server device 200 are integrated, the network 20 may be omitted from the foreign matter detection support system 10.

The product 50 may include various products that require foreign matter management. For example, the product 50 may include a solution or food. The product 50 is in a form that allows acquiring a spectral image of a target material by a spectral camera 101 of the foreign matter detection support device 100. The product 50 may include liquid cosmetics injected into a cosmetic container, perfume injected into a perfume container, various beverages or reagents injected into a container, a specific liquid mineral, or a liquid with a specific concentration. The product 50 may include a transparent container 52 having a level of transparency that allows transmission observation using the spectral camera 101, a liquid substance 53 injected into the transparent container 52, and a cover 51 that encapsulates an entrance of the transparent container 52.

The foreign matter detection support device 100 may include the spectral camera 101 that collects spectral images of the product 50, a lighting device 102 that irradiates designated light to the product 50, a movement support device 103 on which the spectral camera 101 and the lighting device 102 are mounted and movable, a transfer rail 104 along which the movement support device 103 moves, a holder device 105 for fixing the product 50, and a control device 150 that controls each of the above-mentioned components. In an example, the product 50 may be fixed to the holder device 105 with the cover 51 and the transparent container 52 placed horizontally.

The spectral camera 101 performs a function of measuring the light reflectance of an observation target (e.g., the product 50) and converting it into a spectrum. The spectral camera 101 has a feature that it can record a wider wavelength band than an RGB camera, from the ultraviolet region to the infrared region, at a higher resolution than the RGB camera (in a form where the wavelength resolution is higher than that of the RGB camera). Based on this feature, the spectral camera 101 supports more precise inspection of foreign matter when inspecting the inside of a bottled product because the spectra of scratches on the outside of the bottle and foreign matters inside are different. Additionally, the spectral camera 101 may acquire spectral images of various products 50 placed on the holder device 105 and provide the acquired spectral images to the control device 150. The spectral camera 101 may include a plurality of filters to acquire wavelengths of various frequency bands.

While the lighting device 102 irradiates light of a designated illuminance, the spectral camera 101 can move by the transfer rail 104 and the movement support device 103 and acquire spectral images of an upper part of the substance 53 in the transparent container 52 in a designated scheme (e.g., pushbroom scanning or line scanning, snapshot scheme, partial snapshot scheme). Meanwhile, although it is described for example that one spectral camera 101 and one lighting device 102 are used to photograph the product 50, the present disclosure is not limited to this example. In one alternative example, the foreign matter detection support device 100 may include a plurality of spectral cameras 101 and a plurality of lighting devices 102. In another alternative example, the foreign matter detection support device 100 may include only the spectral camera 101 without the lighting device 102, the transfer rail 104, and the movement support device 103.

The foreign matter detection support device 100 may perform analysis on the collected spectral images and determine, based on the analysis results, whether the product 50 contains foreign matter. In this process, the foreign matter detection support device 100 may analyze a data cube corresponding to the collected spectral images, decompose the data cube into pixels, and reconstruct data based on at least some channels by applying a channel management function to the decomposed pixels. The foreign matter detection support device 100 may perform learning to create a foreign matter detection model based on the reconstructed data, and perform foreign matter detection model inference using the learned foreign matter detection model to determine whether a foreign matter is included.

Meanwhile, at least one processing (or operation) of analyzing and processing spectral images for detecting foreign matter, determining whether foreign matter is contained, and generating a learning model may be performed in the foreign matter management server device 200. In this case, the foreign matter detection support device 100 may perform data processing operations differently depending on a design goal. For example, the foreign matter detection support device 100 may be set to perform only spectral image collection and transmission. Alternatively, the foreign matter detection support device 100 may perform at least one of spectral image collection, data cube creation, data reconstruction and model learning based on the reconstructed data, and transmission or operation of the learned model, and may transmit the performance results to the foreign matter management server device 200.

The network 20 may establish a wireless communication channel with the foreign matter detection support device 100 and transmit data generated during the operation of the foreign matter detection support device 100 to the foreign matter management server device 200 or deliver a control message (or control signal) of the foreign matter management server device 200 to the foreign matter detection support device 100. The network 20 may include at least one communication component that supports signal transmission and reception between the foreign matter detection support device 100 and the foreign matter management server device 200. For example, the network 20 may include various hardware components for signal transmission, such as an access point (AP), router, switch, or base station, and software modules for operating the hardware components. The network 20 may be configured to support at least one communication scheme used by the foreign matter detection support device 100 and the foreign matter management server device 200. If the foreign matter detection support device 100 and the foreign matter management server device 200 are integrated, the network 20 may be omitted.

The foreign matter management server device 200 may establish a communication channel with the foreign matter detection support device 100 through the network 20. The foreign matter management server device 200 may receive collected data (e.g., at least one of spectral images or data cubes, data reconstructed according to applying channel management technique, a foreign matter detection model learned based on the reconstructed data, a foreign matter determination result, and a foreign matter determination message) from the foreign matter detection support device 100, and perform the subsequent operations depending on the type of the received data. In one example, the foreign matter management server device 200 may perform an operation that is not performed by the foreign matter detection support device 100 (e.g., at least one of creating a data cube, reconstructing data according to the application of channel management technique, training a foreign matter detection model based on the reconstructed data, determining foreign matter, and transmitting a foreign matter determination message).

As described above, the foreign matter detection support system 10 acquires spectral images of the product 50 and performs data reconstruction under certain conditions necessary to perform channel management for the data cube corresponding to the acquired spectral images and determine whether or not the foreign matter is included. Accordingly, data operations can be performed efficiently, and a spectral camera can be reconfigured including only filters corresponding to necessary channels, thereby supporting the construction of a more reasonable foreign matter detection support system 10.

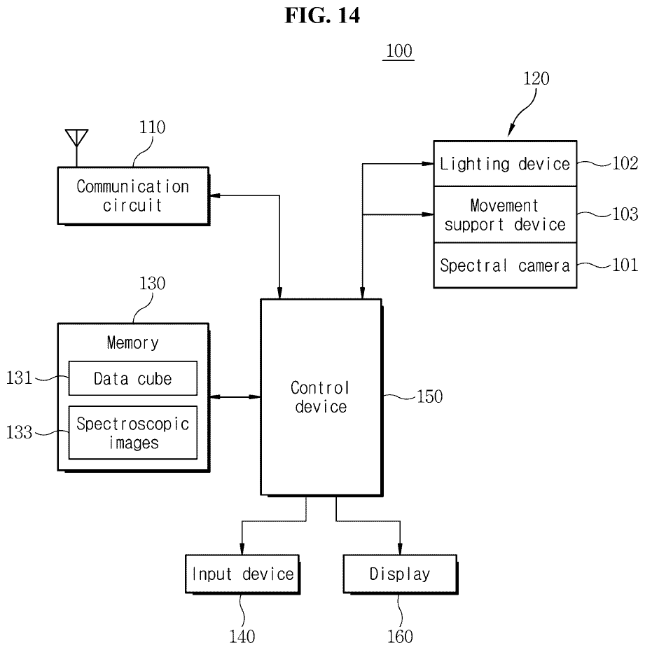

FIG. 14 is a block diagram illustrating a foreign matter detection support device according to the second embodiment of the present disclosure.

Referring to FIGS. 13 and 14, the foreign matter detection support device 100 may include the spectral camera 101, the lighting device 102, the movement support device 103, the transfer rail 104, and the holder device 105. In another example, as described above, the foreign matter detection support device 100 may include one spectral camera, one lighting device, and one movement support device, and may also include the rail (e.g., the transfer rail 104) provided to take spectral images at various positions of the product 50. The foreign matter detection support device 100 may acquire spectral images of the product 50 fixed by the holder device 105 in at least one of the pushbroom scanning scheme, the snapshot scheme, and the spectral scanning scheme, based on a spectral camera group 120 (e.g., the spectral camera 101, the lighting device 102, and the movement support device 103) and the transfer rail 104. For example, the spectral camera group 120 may acquire a plurality of spectral images in units of regions of the product 50 while moving along the transfer rail 104.

Additionally or alternatively, the foreign matter detection support device 100 may include a communication circuit 110, a memory 130, an input device 140, a display 160, and a control device 150 (or processor).

As described above, the foreign matter detection support device 100 may perform operations for detecting foreign matter on the product 50 (e.g., at least one of collection of spectral images, creation of a data cube, decomposition of the data cube, data reconstruction using some channels of the decomposed data, learning of a foreign matter detection model based on the reconstructed data, and foreign matter detection inference regarding the product 50 using the learned foreign matter detection model). In the following description, it is assumed that the foreign matter detection support device 100 performs the functions of collecting spectral images, generating and storing data cubes, and transmitting the acquired data cubes. However, the present disclosure is not limited to this assumption. Alternatively, depending on role division or calculation amount allocation for foreign matter detection, at least one of the above operations for foreign matter detection may be performed by the foreign matter detection support device 100, and the remaining operations may be performed by the foreign matter management server device 200.

The communication circuit 110 may establish a communication channel with the foreign matter management server device 200 via the network 20. Alternatively, the communication circuit 110 may directly establish a communication channel with the foreign matter management server device 200 without going through the network 20. When the foreign matter management server device 200 is designed to perform foreign matter detection for products, the communication circuit 110 may transmit a data cube generated based on spectral images collected by the spectral camera 101 (spectral images collected in line scanning) to the foreign matter management server device 200.

The memory 130 may store at least one program or data necessary for the operation of the foreign matter detection support device 100. In one example, the memory 130 may store a control program required to drive the spectral camera group 120, spectral images 133 acquired through the spectral camera group 120, and a data cube 131 generated based on the spectral images 133.

The input device 140 may create a user input signal necessary for the operation of the foreign matter detection support device 100 in response to a user's manipulation. For example, the input device 140 may create an input signal for manual control of the spectral camera group 120, an input signal requesting the creation and storage of the data cube 131 corresponding to the acquired spectral images (or spectral images acquired by line scanning), an input signal requesting the transmission of the data cube 131, etc. in response to a user's manipulation, and deliver it to the control device 150. In this regard, the input device 140 may include at least one of a keyboard, a keypad, a touch screen, a jog shuttle, a jog stick, a wheel, a mouse, a voice input device, and a gesture input device.

The display 160 may output various information screens necessary for the operation of the foreign matter detection support device 100. For example, the display 160 may output a screen related to the operation of at least one of the spectral camera group 120 and the holder device 105 of the foreign matter detection support device 100. The display 160 may output at least one screen related to the generation process and results of the data cube 131 and the transmission result of the data cube 131. The display 160 may include a touch screen that supports a user input function.

The control device 150 may control to acquire the plurality of spectral images 133 related to the product 50 using the spectral camera group 120 in response to a predefined event or a request from the foreign matter management server device 200. The control device 150 may generate the data cube 131 based on the acquired plurality of spectral images 133 and transmit it to the foreign matter management server device 200. Additionally or alternatively, the control device 150 may receive various control signals related to acquiring the spectroscopic images 133 from the foreign matter management server device 200 and control the spectral camera group 120 according to the received control signal.

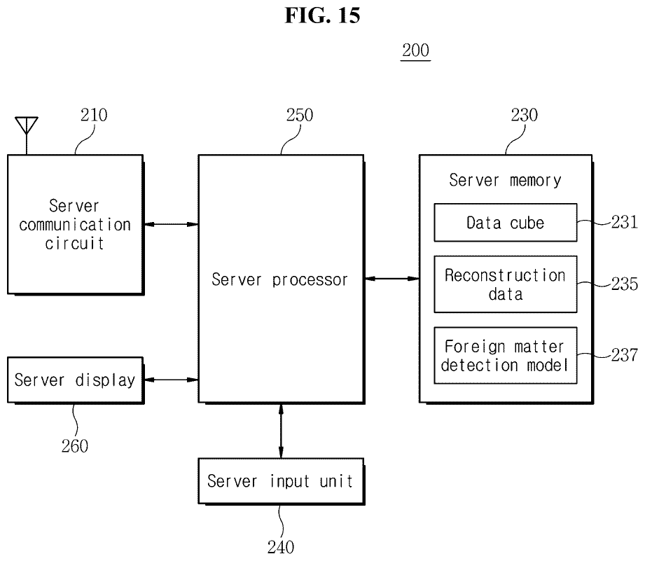

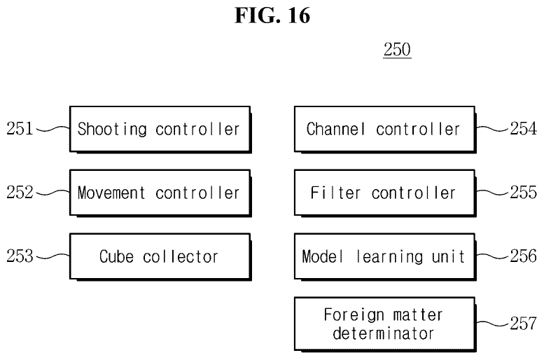

FIG. 15 is a block diagram illustrating a foreign matter management server device according to the second embodiment of the present disclosure. FIG. 16 is a block diagram illustrating a server processor in the foreign matter management server device according to the second embodiment of the present disclosure. As described above, if the foreign matter detection support device 100 is designed to independently support the foreign matter detection support function, the foreign matter management server device 200 may be omitted.

Referring to FIG. 15, the foreign matter management server device 200 may include a server communication circuit 210, a server memory 230, a server input unit 240, a server display 260, and a server processor 250. When the foreign matter detection support device 100 is configured to collect the spectral images 133 for the product 50 and deliver the corresponding data cube 231, the foreign matter management server device 200 may be configured to process the data cube 231 and detect foreign matter.

The server communication circuit 210 may establish a communication channel with the foreign matter detection support device 100 through the network 20 or directly. The server communication circuit 210 may collect a plurality of spectral images and a current spectral image for the product 50 from the foreign matter detection support device 100 in response to a designated period or the occurrence of a predefined event. Alternatively, the server communication circuit 210 may receive the data cube 231 corresponding to the product 50 from the foreign matter detection support device 100.

The server memory 230 may store at least one program or data necessary for the operation of the foreign matter management server device 200. For example, the server memory 230 may store the data cube 231 generated based on a plurality of spectral images provided by the foreign matter detection support device 100, reconstructed data 235 obtained by decomposing the data cube 231 into pixel units and reconstructing selected at least some channels, and a foreign matter detection model 237 created based on the reconstructed data 235.

The server input unit 240 may include mechanisms for receiving various administrator's (or user's) inputs necessary for the operation of the foreign matter management server device 200. For example, the server input unit 240 may include at least one of a keyboard, a keypad, a touch pad, a touch screen, a jog shuttle, a wheel, and a voice input device. The server input unit 240 may create at least one of an input signal requesting connection with the foreign matter detection support device 100, an input signal requesting acquisition of spectral images for the product 50, an input signal requesting decomposition and reconstruction of the data cube 231 and model learning, and an input requesting determination of foreign matter in the product 50 based on the foreign matter detection model 237 in response to an administrator's input, and transmit the created input signal to the server processor 250.

The server display 260 may output at least one screen related to the operation of the foreign matter management server device 200. For example, the server display 260 may output at least one of a screen showing the communication connection status with the foreign matter detection support device 100, a screen showing the process of receiving the data cube 231 from the foreign matter detection support device 100 and generating the reconstructed data 235 based on the received data cube 231, a screen showing the process of creating the foreign matter detection model 237 based on the reconstructed data 235, and a screen showing the process of performing foreign matter detection inference for the product 50 using the learned foreign matter detection model 237.

The server processor 250 may control the transmission and processing of signals necessary for the operation of the foreign matter management server device 200, and the storage, transmission, or output of processing results. The server processor 250 may control the processing and model learning for the data cube 231 and the foreign matter determination for the product 50. Additionally or alternatively, the server processor 250 may perform control related to acquiring a spectral image for the product 50. In this regard, as shown in FIG. 16, the server processor 250 may include at least some of a shooting controller 251, a movement controller 252, a cube collector 253, a channel controller 254, a filter controller 255, a model learning unit 256, and a foreign matter determinator 257, and may perform foreign matter determination based on the corresponding components. The server processor 250 may output the foreign matter determination result on the server display 260 or transmit a message including the foreign matter determination result to a designated portable terminal.

The shooting controller 251 may perform shooting control of the spectral camera 101 included in the foreign matter detection support device 100. In this regard, the shooting controller 251 may control establishing a communication channel with the foreign matter detection support device 100, receiving an image (e.g., RGB image) related to the holder device 105 holding the product 50 from the foreign matter detection support device 100, and outputting the received image on the server display 260. When receiving a user input related to acquiring a spectral image of the foreign matter detection support device 100 through the server input unit 240, the shooting controller 251 may generate a shooting control signal corresponding to the received user input and transmit the generated shooting control signal to the foreign matter detection support device 100. In this process, the shooting controller 251 may create and provide (e.g., transmit to the foreign matter detection support device 100) a light control signal to control light irradiation of the lighting device 102 such that illuminance information necessary to photograph the product 50 is collected (e.g., received from the foreign matter detection support device 100) and light is irradiated with an illuminance corresponding to the collected illuminance information. In the process of acquiring a spectral image of the product 50, the shooting controller 251 may create and provide (e.g., transmit to the foreign matter detection support device 100) a control signal for adjusting the operation timing of the spectral camera 101 and the lighting device 102 in conjunction with the movement controller 252. For example, after acquiring the spectral image of a first line of the data cube 231 corresponding to the product 50, the shooting controller 251 may request the movement controller 252 to move and, when the movement is completed, control the spectral camera 101 and the lighting device 102 to acquire the spectral image of a second line adjacent to the first line. The shooting controller 251 may control movement and shooting repeatedly until all spectral images capable of constructing the data cube 231 corresponding to the product 50 are acquired.

The movement controller 252 may create a control signal for controlling the movement of the spectral camera 101 and the lighting device 102 in conjunction with the shooting controller 251 and provide the created control signal to the foreign matter detection support device 100. For example, the movement controller 252 may collect current location information about the movement support device 103 to which the spectral camera 101 and the lighting device 102 are fixed, from the foreign object detection support device 100. When receiving a signal requesting movement from the shooting controller 251, the movement controller 252 may control the movement of the movement support device 103 and, when the movement request of the shooting controller 251 is terminated, control the movement support device 103 to the initial position.

The cube collector 253 may request the data cube 131 stored in the memory 130 of the foreign matter detection support device 100 and store the data cube received from the foreign matter detection support device 100 in the server memory 230. In this process, the cube collector 253 may enter identification information of the foreign matter detection support device 100 and information related to the product 50 together. If the foreign matter management server device 200 is designed to receive the data cube 231 from the foreign matter detection support device 100, the above-described shooting controller 251 and movement controller 252 may be included in the foreign matter detection support device 100.

The channel controller 254 may perform pixel-level decomposition of the data cube 231. The channel controller 254 may apply channel reduction technique to the data cube decomposed into pixel units. In this process, the channel controller 254 may apply at least one of a channel extraction technique and a channel selection technique to the data cube decomposed into pixel units. The channel extraction technique may include technique for creating a virtual channel and extracting the channel. The virtual channel may be created by applying mathematical theory to the data cube 231 extracted from the spectral camera. In one example, the channel controller 254 may extract virtual dimensions as channels in the data cube 231, based on principal component analysis (PCA) (or SuperPCA or a technique based on linear algebra theory) or uniform manifold approximation and projection (UMAP) (or a technique based on mathematical theory related to manifold theory). In relation to the channel selection technique, the channel controller 254 may remove unnecessary channels in detecting foreign matter. In this regard, the channel controller 254 may select a channel required for foreign matter detection by applying at least one of a heuristic method, a purity-based method, and an entropy-based method to the data cube decomposed into pixel units. The channel controller 254 may perform data reconstruction of the data cube to which the channel reduction technique is applied. For example, the channel controller 254 may exclude the removed channels and then rearrange and reconstruct the remaining channels according to a predefined rule. The channel controller 254 may store the result derived from the channel reduction technique in a designated physical space (e.g., the server memory 230) or a virtual server.

The filter controller 255 may collect channel selection information from the channel controller 254 and output information for reconstructing the camera filter of the spectral camera 101 based on the collected channel selection information. In this regard, the spectral camera 101 may include a plurality of wavelength filters that transmit only light of a specific wavelength, or may include a variable wavelength filter that can change the transmission wavelength. When the spectral camera 101 includes the variable wavelength filter, the filter controller 255 may generate a filter control value of the variable wavelength filter for transmitting light in the wavelength band corresponding to the channel selection information, and provide the generated filter control value to the foreign matter detection support device 100. Alternatively, the filter controller 255 may output filter setting information to the display 160 or the server display 260 so that the spectral camera 101 acquires light in a specific wavelength range. Alternatively, the filter controller 255 may provide filter setting information to the user terminal of an administrator who has filter control authority for the spectral camera 101. Through this, by configuring the spectral camera 101 to include only some filters, the filter controller 255 can help reduce the cost required to build the spectral camera for acquiring spectral images. Alternatively, by controlling to obtain only light in some wavelength ranges, the filter controller 255 can help to reduce the amount of computation and time (or inference time) required for wavelength analysis. Even if the filter settings are changed, the foreign matter detection performance of the foreign matter detection support device 100 or the foreign matter management server device 200 may be improved. The spectral camera whose filter settings are controlled or newly configured by the filter controller 255 may have at least one fewer filter than the previous spectroscopic camera.

The model learning unit 256 may support learning of the foreign matter detection model 237 in relation to foreign matter determination. In this regard, the model learning unit 256 may perform machine learning on the reconstructed data cubes 231 when a given number or more of the reconstructed data cubes 231 are secured. In this process, the model learning unit 256 may generate at least one of a learning model for a data cube in a normal state and a learning model for a data cube reconstructed by selecting a foreign matter-related channel. The model learning unit 256 may perform at least one of supervised learning and unsupervised learning in relation to generating at least one learning model. In the case of the machine learning model, the model learning unit 256 may perform learning based on Support Vector Machine (SVM) and K-nearest neighbor in, and Deep SVDD, and in the case of the deep learning model, the model learning unit 256 may selectively use one or more of fully-connected, convolution, recurrent, graph, and transformer in configuring Deep SVDD, Convolutional Neural Networks, a discriminator based on supervised learning, and a generator based on unsupervised learning. However, the model generation method of the present disclosure is not limited to the specific method described above, and various modifications or new model generation methods may be applied.

Upon acquiring the data cube for the product 50 to determine foreign matter, the foreign matter determinator 257 may reconstruct the data by applying the same channel reduction technique, applied to the learning model, to the acquired data cube. The foreign matter determinator 257 may apply the learning-completed foreign matter detection model 237 to the reconstructed data and, based on this, determine whether foreign matter is contained in the data cube of the current product 50. As mentioned above, the product 50 may be various objects such as solutions and foods. The foreign matter determinator 257 may store the determination result in the server memory 230, provide it to the foreign matter detection support device 100, or provide it to the user terminal of the requester who requested whether the product 50 contains foreign matter.

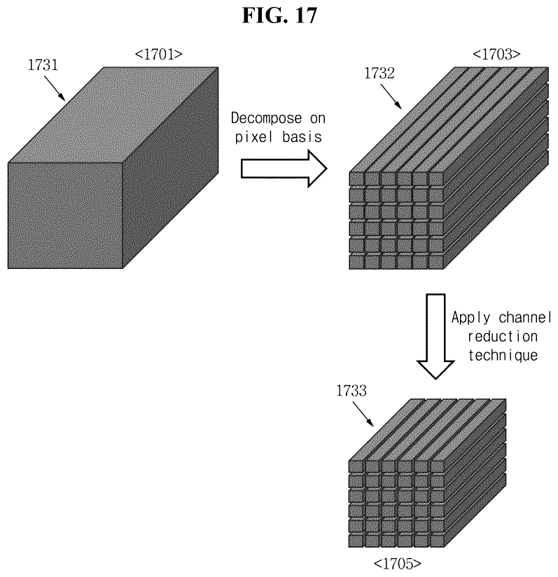

FIG. 17 is a diagram illustrating a channel reduction technique according to the second embodiment of the present disclosure. Hereinafter, it will be described for example that the foreign matter detection support device 100 performs a channel reduction technique. However, the present disclosure is not limited to this example, and the channel reduction technique may be performed by the foreign matter management server device 200.

Referring to FIGS. 13 to 17, the foreign matter detection support device 100 may acquire a spectral image of the product 50 through control of the spectral camera 101. In this process, the foreign matter detection support device 100 may control the spectral camera 101 to acquire spectral images for each window in a predefined line unit (or patch unit of a certain area) for the product 50 and, as in state 1701, generate a data cube 1731 based on synthesis of the acquired spectral images for each window.

As in state 1703, the foreign matter detection support device 100 may perform pixel-level decomposition on the generated data cube 1731. The overall data size of the data cube 1731 to which pixel-level decomposition is applied is maintained, and coordinate values for each pixel-level region of the data cube 1731 may be defined.

As in state 1705, the foreign matter detection support device 100 may apply channel reduction technique to the data cube 1732 decomposed into pixels, reconstruct the data to which the channel reduction technique is applied, and create reconstructed data 1733. For example, the foreign matter detection support device 100 may allocate virtual channels to respective pixel units for the data cube 1732 decomposed into the pixel units, and select or exclude at least some of the allocated virtual channels based on a mathematical algorithm pre-stored in the server memory 230 (or a program corresponding to a mathematical theory selected by a user input), thereby reducing the number of channels. The foreign matter detection support device 100 may generate the reconstructed data 1733 by reconfiguring the reduced channels according to a predefined rule.

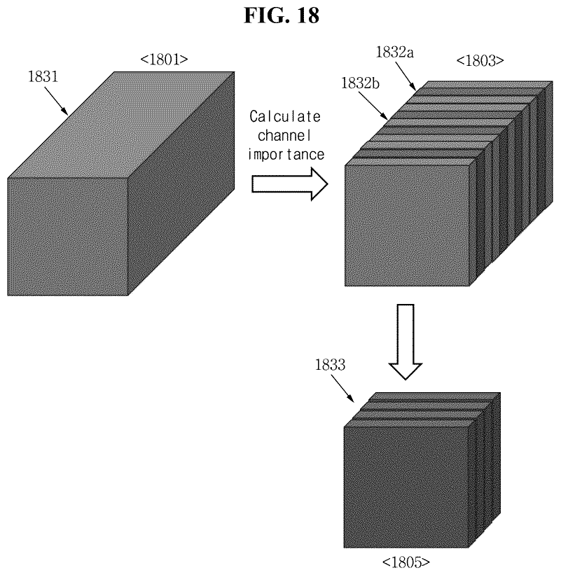

FIG. 18 is a diagram illustrating a channel selection technique according to the second embodiment of the present disclosure. Hereinafter, it will be described for example that the foreign matter management server device 200 performs a channel selection technique. However, the present disclosure is not limited to this example, and the channel selection technique may be performed by the foreign matter detection support device 100.

Referring to FIGS. 13 to 18, the foreign matter detection support device 100 may acquire a spectral image of the product 50 through control of the spectral camera 101. In this process, the foreign matter detection support device 100 may acquire spectral images for each window in a predefined line unit (or patch unit of a certain area) for the product 50 by controlling the spectral camera 101 and, as in state 1801, create a data cube 1831 based on synthesis of the acquired spectral images for each window.

The foreign matter detection support device 100 may calculate the importance of spectral image channels for each window with respect to the data cube 1831. For example, the foreign matter detection support device 100 may statistically or empirically calculate the probability of detecting a foreign matter for each of the channels corresponding to the window of the data cube 1831. Alternatively, the foreign matter detection support device 100 may calculate the foreign matter detection probability for each channel based on at least one of various methods such as a heuristic method, purity-based method, and entropy-based method. Alternatively, the foreign matter detection support device 100 may calculate the importance of each channel related to foreign matter detection by applying a technology (or algorithm) based on mathematical theory such as PCA (or SuperPCA) and UMAP to the channels for each window of the data cube 1831. As in state 1803, the foreign matter detection support device 100 may define an important channel 1832a whose contribution to the foreign matter detection probability is relatively high compared to other channels or whose foreign matter detection probability is greater than a predefined reference value, and a secondary channel 1832b whose contribution to the foreign matter detection probability is relatively low compared to other channels or whose foreign matter detection probability is less than a predefined reference value.

When the important channel 1832a and the secondary channel 1832b are defined, the foreign matter detection support device 100 may generate reconstructed data 1833 by separately extracting only the important channels 1832a, as in state 1805. Alternatively, the foreign matter detection support device 100 may select the important channels 1832a by removing the secondary channels 1832b. The foreign matter detection support device 100 may synthesize the selected important channels 1832a and separately record location information for each channel.

As described above, the foreign matter detection support device 100 filters out data unnecessary for foreign matter detection by using the channel reduction technique, thereby reducing the cost (e.g., design cost of the spectral camera) required for foreign matter detection by the foreign matter detection support device 100, reducing the size or amount of data to be processed, and improving the foreign matter detection speed.

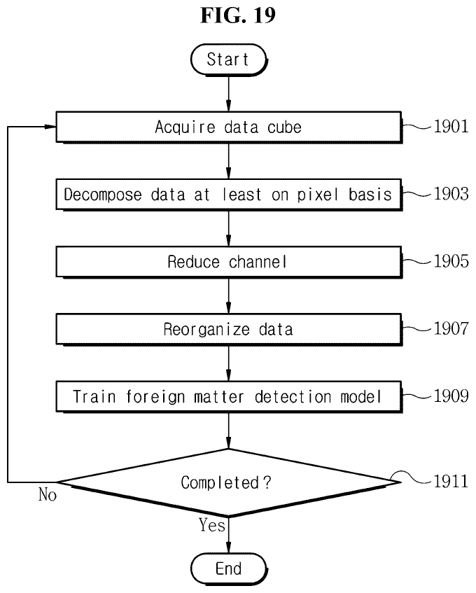

FIG. 19 is a flowchart illustrating a foreign matter detection model learning method related to the foreign matter detection function according to the second embodiment of the present disclosure. Hereinafter, it will be described for example that the foreign matter detection support device 100 performs a foreign matter detection related method. However, the present disclosure is not limited to this example, and the foreign matter detection related method may be performed by the foreign matter management server device 200.

Referring to FIGS. 13 to 19, in relation to the foreign matter detection model learning method, the control device 150 of the foreign matter detection support device 100 (or the server processor 250 of the foreign matter management server device 200) may perform data cube acquisition in step 1901. In this regard, the foreign matter detection support device 100 may collect spectral images of the product 50 by controlling the spectral camera 101 arranged to photograph the product 50 mounted in the holder device 105. In this process, the control device 150 may collect spectral images for each window (e.g., each line) of a predefined size for the product 50, combine the collected spectral images (e.g., spectral images for each line), and create a data cube for the product 50.

In step 1903, the control device 150 of the foreign matter detection support device 100 may perform data decomposition of the data cube into pixel units of a predefined size. For example, the control device 150 may decompose the data cube into pixel units (same as or similar to spectrum units) in each window created through a sliding window, and obtain decomposed pixels. In relation to decomposing the data cube in at least one pixel unit, a region of a certain size may be determined as a decomposition region in a pixel unit, without decomposing the entire data cube into at least one pixel unit. To determine the pixel-level decomposition region, the control device 150 may perform data cube search. For example, the control device 150 of the foreign matter detection support device 100 may search the entire or part of the data cube with a sliding window of a certain size or more specified by the user, or search the entire or part of the data cube by setting the sliding window as a hyper-parameter in an algorithm for data cube search and automatically selecting the optimal sliding window. In the data cube decomposition, the control device 150 of the foreign matter detection support device 100 may differently determine the number of pixels to be decomposed, depending on the size of the data cube or the computing capacity (or computing performance) of the foreign matter detection support device 100. When a plurality of pixels are determined, the control device 150 may decompose the data cube into a plurality of pixel groups.

In step 1905, the control device 150 of the foreign matter detection support device 100 may perform channel reduction based on the decomposed pixels. For example, the control device 150 may create a virtual channel by applying a predefined mathematical theory to the data cube extracted from the spectral camera. For example, the control device 150 may extract virtual dimensions as virtual channels in the data cube, based on principal component analysis (PCA) (or SuperPCA or a technique based on linear algebra theory) or uniform manifold approximation and projection (UMAP) (or a technique based on mathematical theory related to manifold theory). The control device 150 may remove unnecessary channels when detecting foreign matter. For example, the control device 150 may apply at least one of a heuristic method, a purity-based method, and an entropy-based method to the data cube to select channels necessary for foreign matter detection or remove unnecessary channels.

In step 1907, the control device 150 of the foreign matter detection support device 100 may perform reconstruction of data with a reduced channel. For example, the control device 150 may exclude the removed channels and rearrange and reorganize the remaining channels according to a predefined rule. In relation to this, the control device 150 may continuously arrange selected channels so that there is no empty space of channels removed due to channel reduction. In this process, the control device 150 may record location information of the removed channel in the data cube or location information of the selected channel in the data cube.

In step 1909, the control device 150 of the foreign matter detection support device 100 may perform foreign matter detection model learning on the channel-reduced reconstructed data. For example, when the channel-reduced reconstructed data is generated by selecting a channel with a high probability of foreign matter detection, the foreign matter detection model may include a model for a portion of the product 50 where foreign matter exists. The foreign matter detection support device 100 may perform training on a foreign matter detection model when a predefined number or more of the reconstructed data are accumulated.

In step 1911, the control device 150 of the foreign matter detection support device 100 may check whether learning of the foreign matter detection model is completed, and if learning of the foreign matter detection model is not completed, return to the step 1901 and re-performs the subsequent operations. When learning of the foreign matter detection model is completed, the control device 150 of the foreign matter detection support device 100 may notify the completion of learning for the foreign matter detection model, store the learned foreign matter detection model in the memory or provide it to a designated device (e.g., the foreign matter management server device 200).

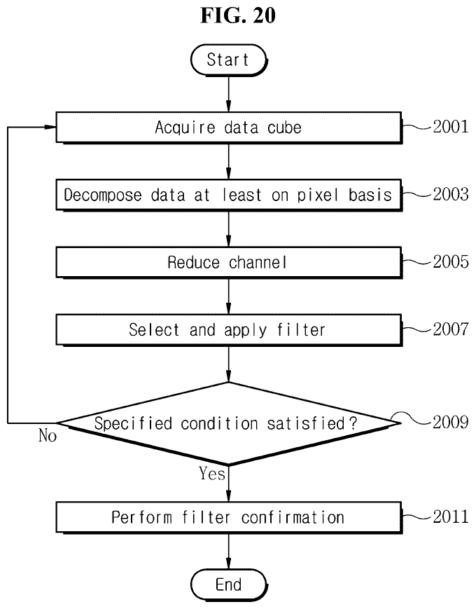

FIG. 20 is a flowchart illustrating a filter setting method related to the foreign matter detection function according to the second embodiment of the present disclosure.

Referring to FIGS. 13 to 20, in relation to the foreign matter detection model learning method, the control device 150 of the foreign matter detection support device 100 (or the server processor 250 of the foreign matter management server device 200) may acquire a data cube in step 2001, decompose data into pixels in step 2003, and perform channel reduction on the pixel-level decomposed data in step 2005. The data cube acquisition, pixel-level decomposition, and channel reduction operations performed in the steps 2001 to 2005 may be substantially the same as or similar to the data cube acquisition, pixel-level decomposition, and channel reduction operations in the steps 1901 to 1905 previously described in FIG. 19.

In step 2007, the control device 150 of the foreign matter detection support device 100 may select and apply a filter based on information about channels selected or removed during the channel reduction process. For example, when the spectral camera 101 includes a variable wavelength filter, the control device 150 may control the filtering value of the variable wavelength filter to change. Alternatively, when the spectral camera 101 includes mechanical filters, the control device 150 may support changing a filter design by outputting information about filters corresponding to selected or removed channels to the display 160.

In step 2009, the control device 150 of the foreign matter detection support device 100 may check whether the current state satisfies a specified condition. For example, the control device 150 may check whether the steps 2001 to 2007 have been performed a predefined number of times or more. If the number of operations is less than the predefined number of times, the control device 150 may return to the step 2001 and re-perform the subsequent operations. Alternatively, the control device 150 may check whether the foreign matter detection function is performed normally based on the currently selected filter design value. For example, the control device 150 may calculate the minimum filter setting value capable of foreign matter detection while performing the steps 2001 to 2007 using at least one product containing foreign matter.

If the specified condition is satisfied, the control device 150 of the foreign matter detection support device 100 may perform filter confirmation in step 2011. The control device 150 may record the confirmed filter setting value and notify it.

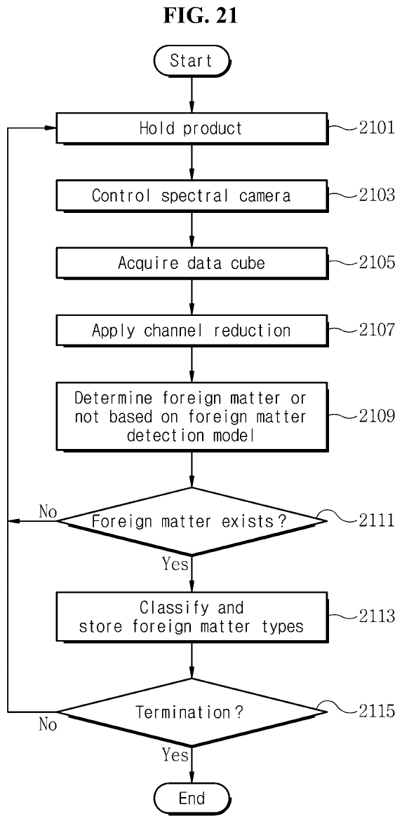

FIG. 21 is a flowchart illustrating a model operation related to the foreign matter management method for liquid products according to the second embodiment of the present disclosure.

Referring to FIG. 21, in step 2101, the product 50 may be mounted in the holder device 105 of the foreign matter detection support device 100. The product 50 is an article that requires detection of foreign matter and may include various articles such as solutions, containers containing solutions, and food that require detection of foreign matter. Mounting the product 50 in the holder device 105 may be performed by various mechanical structures (e.g., conveyor belt) or by an operator.

In step 2103, when the product 50 is placed in the holder device 105, the control device 150 of the foreign matter detection support device 100 may acquire a spectral image for the product 50 by controlling the spectral camera 101. In this process, the control device 150 may acquire a spectral image of the product 50 using a slide window method while moving the spectral camera 101.

In step 2105, the control device 150 of the foreign matter detection support device 100 may generate a data cube based on the acquired spectral image. For example, the control device 150 may generate the data cube by combining the spectral images acquired using a slide window method.

In step 2107, the control device 150 of the foreign matter detection support device 100 may apply channel reduction to the data cube. In this regard, the control device 150 may obtain channel reduction information applied to a foreign matter detection model for foreign matter determination, and perform channel reduction for the currently acquired data cube based on the obtained channel reduction information. The channel reduction information applied to the foreign matter detection model may be secured from the memory 130 or the foreign matter management server device 200. The control device 150 may select some of the channels of the current data cube or remove unnecessary channels based on preset channel selection information or channel removal information. Additionally or alternatively, the control device 150 may precede pixel-level decomposition of the data cube and perform channel reduction on the data cube decomposed into pixel units. Additionally, the control device 150 may obtain reconstructed data by performing data reconstruction on channels selected by channel reduction or remaining channels after some channels are removed.

In step 2109, the control device 150 of the foreign matter detection support device 100 may apply the channel-reduced data or reconstructed data to a previously stored foreign matter detection model (or a foreign matter detection model acquired from the foreign matter management server device 200) and thereby determine whether there is a foreign matter or not. For example, the control device 150 may input currently reconstructed data into a foreign matter detection model and check whether the resulting value is within a certain range of at least one of a predefined average value, variance value, and maximum value.

In step 2111, when the resulting value of the reconstructed data is outside a reference range, the control device 150 of the foreign matter detection support device 100 may determine that the foreign matter does not exist, control to output the result (e.g., no foreign matter), and then return to the step 2101. On the other hand, if the resulting value of the reconstructed data is within the reference range (e.g., if the similarity with a model containing the foreign matter is greater than or equal to a reference value), the control device 150 of the foreign matter detection support device 100 may classify and store the type of the foreign matter in step 2113. Additionally or alternatively, the control device 150 of the foreign matter detection support device 100 may output a foreign matter determination result. For example, the control device 150 may output the foreign matter determination result of the product 50 on the display 160 or transmit it as a message to a pre-designated user terminal (or administrator terminal).

In step 2115, the control device 150 of the foreign matter detection support device 100 may check whether there is an event related to termination of the foreign matter detection function. For example, when there is a user input for terminating the foreign matter detection function or when the time for which the product 50 is not placed in the holder device 105 is longer than a reference time, the control device 150 may determine that the foreign matter detection function is terminated. In order to determine whether the product 50 is placed in the holder device 105, the foreign matter detection support device 100 may include a separate sensor disposed in the holder device 105 or further include a separate monitoring device for monitoring the holder device 105. If there is no termination event or the product 50 is placed in the holder device 105 within the specified time, the control device 150 may return to the step 2101 and re-perform the subsequent operations.

As described above, the foreign matter detection method according to an embodiment of the present disclosure can provide a method for detecting foreign matter by reducing channels that are easy to detect foreign matter in the data cube acquired from the product 50 (or object). In this process, a method of applying the channel reduction technique that facilitates the detection of foreign matter in the data cube may include the channel selection technique and the channel extraction technique. The foreign matter detection method may involve searching the data cube with a window of a certain size or more using data calculated through the channel reduction technique, storing the calculated data in a specific storage space, and/or specifying one or more foreign matter with the calculated data. In addition, the foreign matter detection method may operate a machine learning or deep learning-based artificial intelligence model that determines whether the foreign matter exists based on the calculated data when requested by the user.

The foreign matter detection method may include an operation of extracting one or more channels that can well reflect the characteristics of the data from the calculated data in relation to the channel selection technique in the data cube, and in this operation, various methods such as a heuristic method, a purity-based method, or an entropy-based method may be used. The foreign matter detection method may include an operation of extracting one or more new dimensions that can well reflect the characteristics of the data from the calculated data in the process of applying the channel extraction technique to the data cube, and this operation may use techniques based on linear algebra theory such as PCA or techniques based on manifold theory such as UMAP.

While the specification contains many specific implementation details, these should not be construed as limitations on the scope of the present disclosure or of what may be claimed, but rather as descriptions of features that may be specific to particular embodiments of particular disclosure.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

What is claimed is:

1. A foreign matter management device comprising:
a spectral camera acquiring a spectral image of a liquid product including a liquid substance injected therein;
a memory storing the spectral image; and
a processor functionally connected to the spectral camera and the memory,
the processor configured to:
acquire a data cube corresponding to the spectral image captured for the liquid substance of the liquid product,
divide the data cube into windows of a predetermined size,
calculate a current relationship matrix indicating a relationship between pixel values included in the divided windows, and
determine whether the liquid product contains a foreign matter, based on the current relationship matrix.

2. The foreign matter management device of claim 1, wherein the processor is configured to:
search all or part of the data cube with a sliding window of a size specified by a user input, or search all or part of the data cube by setting the sliding window as a hyper-parameter within an algorithm stored in the memory and automatically selecting an optimal sliding window.

3. The foreign matter management device of claim 1, wherein the processor is configured to:
search the data cube with a sliding window of a specified size, divide each sliding window into at least one pixel unit, calculate similarities between divided pixel unit values, and calculate the current relationship matrix based on the calculated similarities.

4. The foreign matter management device of claim 3, wherein the processor is configured to:
calculate the similarities by applying a cosine similarity function.

5. The foreign matter management device of claim 1, wherein the processor is configured to:
when a similarity different from surrounding similarities by more than a reference value is detected from among the similarities, determine that the liquid product corresponding to the current relationship matrix contains a foreign matter.

6. The foreign matter management device of claim 1, wherein the processor is configured to:
search the data cube with a sliding window of a specified size, divide each sliding window into at least one pixel unit, calculate distance values between divided pixel unit values, and calculate the current relationship matrix based on the calculated distance values.

7. The foreign matter management device of claim 6, wherein the processor is configured to:
calculate the distance values by applying a Euclidean distance function.

8. The foreign matter management device of claim 1, wherein the processor is configured to:
when a distance value different from surrounding distance values by more than a reference value is detected from among the distance values, determine that the liquid product corresponding to the current relationship matrix contains a foreign matter.

9. The foreign matter management device of claim 1, wherein the memory stores at least one of a relationship matrix including foreign matter and a relationship matrix including no foreign matter, and
wherein the processor is configured to:
compare the relationship matrix including foreign matter and the current relationship matrix, and if a comparison result has a similarity greater than or equal to a reference value, determine that the liquid product corresponding to the current relationship matrix contains a foreign matter, or
compare the relationship matrix including no foreign matter with the current relationship matrix, and if a comparison result has a similarity less than a reference value, determine that the liquid product corresponding to the current relationship matrix contains a foreign matter.

10. The foreign matter management device of claim 1, wherein the processor is configured to:
provide a machine learning or deep learning-based artificial intelligence model based on at least one of the data cube and the current relationship matrix.

11. The foreign matter management device of claim 1, wherein the spectral camera includes:
a first spectral camera that photographs the liquid product in an upward direction; and
a second spectral camera that photographs the liquid product in a downward direction, and
wherein the processor:
when detection of suspended matter of the liquid product is requested, control to collect spectral images based on the first spectral camera, and
when detection of sediment of the liquid product is requested, control to collect spectral images based on the second spectral camera.

12. A foreign matter management method for a liquid product, comprising:
acquiring a data cube corresponding to a spectral image captured for a liquid substance of the liquid product;
dividing the data cube into windows of a predetermined size;
calculating a current relationship matrix indicating a relationship between pixel values included in the divided windows; and
determining whether the liquid product contains a foreign matter, based on the current relationship matrix.

13. A foreign matter management device comprising:
a spectral camera acquiring a spectral image of a liquid product including a liquid substance injected therein;
a memory storing the spectral image; and
a processor functionally connected to the spectral camera and the memory,
the processor configured to:
acquire a data cube corresponding to the spectral image captured for the liquid substance of the liquid product,
search the data cube by sliding with windows of a given size,
allocate data existing inside or outside the windows in a search result to virtual nodes,
allocate edges establishing relationships between the virtual nodes,
calculate a graph including the virtual nodes and the edges, and
based on the graph, determine whether the liquid product contains a foreign matter.

14. The foreign matter management device of claim 13, wherein the processor is configured to:
calculate a relationship matrix based on the virtual nodes and the edges.

15. The foreign matter management device of claim 13, wherein the processor is configured to:
map respective values representing of the windows to the virtual nodes.

16. The foreign matter management device of claim 13, wherein the processor is configured to:
allocate the virtual nodes based on at least one of machine learning including linear regression, deep learning including convolutional neural networks (CNN), and values for expressing as basic statistics of the windows.

17. The foreign matter management device of claim 13, wherein the processor is configured to:
calculate similarities between the virtual nodes and allocate the edges based on the similarities.

18. The foreign matter management device of claim 17, wherein the processor is configured to:
determine whether the foreign matter is contained, based on sizes of the similarities.

19. The foreign matter management device of claim 18, wherein the processor is configured to:
calculate the similarities by applying a cosine similarity function.

20. The foreign matter management device of claim 13, wherein the processor is configured to:
calculate distance values between the virtual nodes and allocate the edges based on the distance values.

21. The foreign matter management device of claim 20, wherein the processor is configured to:
determine whether the foreign matter is contained, based on sizes of the distance values.

22. The foreign matter management device of claim 21, wherein the processor is configured to:
calculate the distance values by applying a Euclidean distance function.

23. The foreign matter management device of claim 13, wherein the processor is configured to:
create and provide an artificial intelligence model based on machine learning or deep learning by using the virtual nodes in response to a user input,
create a relationship matrix based on the virtual nodes and create and provide an artificial intelligence model based on graph theory, or
create and provide an artificial intelligence model corresponding to the virtual nodes based on unsupervised learning including a K-nearest neighbors scheme.

24. A foreign matter management method for a liquid product, comprising:
acquiring a data cube corresponding to a spectral image captured for liquid substance of the liquid product;
searching the data cube by sliding with windows of a given size;
allocating data existing inside or outside the windows in a search result to virtual nodes;
allocating edges establishing relationships between the virtual nodes;
calculating a graph including the virtual nodes and the edges; and
based on the graph, determining whether the liquid product contains a foreign matter.

25. A foreign matter detection support device comprising:
a spectral camera acquiring a spectral image of a product;
a memory storing the spectral image; and
a processor functionally connected to the spectral camera and the memory,
the processor configured to:
acquire a data cube corresponding to the spectral image,
perform channel reduction to remove at least some of channels corresponding to the data cube,
generate reconstructed data by reconstructing channel-reduced data, and
perform learning on a foreign matter detection model based on the reconstructed data.

26. The foreign matter detection support device of claim 25, wherein the processor is configured to:
perform pixel-level decomposition on the generated data cube, and
perform the channel reduction on the data cube decomposed into pixels.

27. The foreign matter detection support device of claim 25, wherein the processor is configured to:
extract dimensions representing characteristics of respective portions of the data cube by applying principal component analysis (PCA) or uniform manifold approximation and projection (UMAP) to the data cube, and
map the extracted dimensions to virtual channels.

28. The foreign matter detection support device of claim 25, wherein the processor is configured to:
apply at least one of a heuristic method, a purity-based method, and an entropy-based method in relation to the channel reduction, and
select at least one channel whose importance related to foreign matter detection is higher than a predefined reference value from among the channels corresponding to the data cube.

29. The foreign matter detection support device of claim 25, wherein the processor is configured to:
in relation to the channel reduction, remove at least one channel whose importance related to foreign matter detection is less than a predefined reference value from among the channels corresponding to the data cube.

30. The foreign matter detection support device of claim 25, wherein the processor is configured to:
identify a wavelength band of the spectral image corresponding to channels selected according to a channel reduction result, and
change a setting value of a variable wavelength filter of the spectral camera to transmit light in the identified wavelength band, or output a message requesting a filter setting change of the spectral camera.

31. A foreign matter detection method, performed by a control device of a foreign matter detection support device, comprising:
acquiring a data cube corresponding to a spectral image of a product;
performing channel reduction to remove at least some of channels corresponding to the data cube;
generating reconstructed data by reconstructing channel-reduced data; and
performing learning on a foreign matter detection model based on the reconstructed data.
